(19) United States
(12) Patent Application Publication
(10) Pub. No.: US 2015/0127636 A1
(43) Pub. Date: May 7, 2015

(54) AUTOMATED EVENT ATTENDEE DATA COLLECTION AND DOCUMENT GENERATION APPARATUSES, METHODS AND SYSTEMS

(71) Applicant: Guesterly LLC, Salt Lake City, UT (US)

(72) Inventors: Rachel Hofstetter, Salt Lake City, UT (US); Lorne Hofstetter, Salt Lake City, UT (US)

(73) Assignee: GUESTERLY LLC, Salt Lake City, UT (US)

(21) Appl. No.: 14/533,973

(22) Filed: Nov. 5, 2014

Related U.S. Application Data
(60) Provisional application No. 61/900,318, filed on Nov. 5, 2013.

(51) Int. Cl. G06F 17/30; H04L 29/08; H04L 12/18

(52) U.S. Cl. CPC G06F 17/30943; H04L 12/1813; H04L 67/10
USPC 707/722

(57) ABSTRACT

The AUTOMATED EVENT ATTENDEE DATA COLLECTION AND DOCUMENT GENERATION APPARATUSES, METHODS AND SYSTEMS (“GST”) transform pre-event guest data aggregation inputs using GST components into customized pre-event documents. In some implementations, the disclosure provides a processor-implemented method of aggregating visual and textual guest data from social media servers and combining the aggregated responses with attendee supplemental responses and template document definitions to produce pre-event document output.

This application is a non-provisional of and claims priority under 35 USC §119 to: U.S. provisional patent application Ser. No. 61/900,318 filed Nov. 5, 2013, entitled “AUTOMATED EVENT ATTENDEE DATA COLLECTION AND DOCUMENT GENERATION APPARATUSES, METHODS AND SYSTEMS,” attorney docket no. GUES-001/00US 320965-2001.

The entire contents of the aforementioned application(s) are expressly incorporated by reference herein.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address the collection, aggregation and filtering of event related data and the creation of template driven event documents, and more particularly, include AUTOMATED EVENT ATTENDEE DATA COLLECTION AND DOCUMENT GENERATION APPARATUSES, METHODS AND SYSTEMS.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Individuals have accounts with social media providers and various online services. The individuals may post to their social media accounts information about themselves including their location, photos, friends, and/or the like. Users with social media accounts may attend events with users who are not linked to them via a social network. Event invitations may be sent via postal mail, electronic mail, and/or the like and often include details about the event such as the date, time, place and purpose of the gathering.

### BRIEF DESCRIPTION OF THE DRAWINGS

The accompanying appendices and/or drawings illustrate various non-limiting, example, innovative aspects in accordance with the present descriptions:

FIG. 1 is an example block diagram of a GST computer system, in one embodiment of the GST;

FIG. 2 is an example block diagram showing a hardware configuration of a device that may be used in connection with the GST, in one embodiment of the GST;

FIG. 3 is an example logic flow diagram showing embodiments of collecting data and creating a photo-bio book, in one embodiment of the GST;

FIG. 4 is an example block diagram showing a computer system configuration that may be used in connection with the GST, in one embodiment of the GST;

FIG. 5 is an example logic flow diagram showing embodiments of collecting data and creating a photo-bio book, in one embodiment of the GST;

FIG. 6 is an example block diagram showing a computer system configuration that may be used in connection with the GST, in one embodiment of the GST;

FIG. 7 is an example logic flow diagram that describes aspects of collecting data and creating a photo-bio book, in one embodiment of the GST;

FIG. 8 is an example block diagram showing a computer system configuration that may be used in connection with the GST, in one embodiment of the GST;

FIG. 9 is an example logic flow diagram illustrating embodiments of collecting data for a photo-bio book, in one embodiment of the GST;

FIG. 10 is an example block diagram illustrating an example user interface for inputting a name list, in one embodiment of the GST;

FIG. 11 is an example logic flow diagram illustrating GST embodiments directed to how a list of names to be included in photo-bio book may be matched with data elements that are stored on a server or database, in one embodiment of the GST;

FIG. 12 is an example block diagram showing embodiments of a user interface for displaying thumbnail images and text elements of people that are stored on a server and database, in one embodiment of the GST;

FIG. 13 is an example logic flow diagram showing embodiments of collecting data for a photo-bio book, in one embodiment of the GST;

FIG. 14 is an example block diagram illustrating embodiments of a user interface that may be used to collect data, from one or more users, for a photo-bio book, in one embodiment of the GST;

FIG. 15 is an example logic flow diagram illustrating aspects of collecting data, from one or more users, for a photo-bio book, in one embodiment of the GST;

FIG. 16 is an example logic flow diagram illustrating aspects of collecting data for a photo-bio book, in one embodiment of the GST;

FIG. 17 is an example logic flow diagram illustrating embodiments of automatically using data to create a photo-bio book, in one embodiment of the GST;

FIG. 18 is a block diagram illustrating embodiments of formatting and layout for a photo-bio book, in one embodiment of the GST;

FIG. 19 is a block diagram illustrating an example photo-bio book as displayed on a user device, in one embodiment of the GST;

FIG. 20 is a block diagram illustrating embodiments of displaying a photo-bio book on a user device, in one embodiment of the GST;

FIG. 21 shows an example data flow illustrating aspects of automated pre-event data gathering and template population, in one implementation of the GST operation;

FIG. 22 shows an example logic flow illustrating aspects of pre-event document template selection and population, e.g., an example PETP Component, in one implementation of the GST operation; and

FIG. 23 shows a block diagram illustrating aspects of an exemplary embodiment of a GST user interface controller, in one implementation of the GST operation.

### DETAILED DESCRIPTION

### GST

The AUTOMATED EVENT ATTENDEE DATA COLLECTION AND DOCUMENT GENERATION APPARATUSES, METHODS AND SYSTEMS (hereinafter “GST” user interface) transform guest data aggregation inputs, via GST components, into modified pre-event document templates and pre-event document outputs. In some embodiments, this is carried out in real time.

In one embodiment, the GST relates to systems and methods for collecting media about a group of people and automatically formatting said media into a pre-event document output for print or digital display. Media elements featured in book may include one or more images, text, video recordings, audio recordings, and/or the like. More specifically, the present invention relates to the automated gathering of said media elements and automated formatting of media elements into pre-event document output that features a group of people.

People regularly attend events (i.e. weddings, reunions, summer camp, conferences, meetings) and are part of groups (college classes, cohorts, volunteer organizations, executive programs). Often, an event administrator or group organizer would like to facilitate community building and introductions to help create long-term valuable connections. By allowing an event administrator or group organizer to create a pre-event document output about the confirmed-attendees, the organizer can accelerate the process of creating a community and developing personal connections. In the present invention the term “pre-event document output” or “photo-bio book” may refer to a medium, in printed form, digital form, and/or the like to present formatted data about one or more confirmed-attendees. A pre-event document output (photo-bio book) may consist of a front cover, a back cover, and a plurality of pages featuring images and biographical information about confirmed-attendees. A pre-event document output may also include information like programs and seating assignments, maps, itineraries, and audio and/or video recordings. In one embodiment, by utilizing public and/or readily available media from a variety of sources the event administrator can be respectful of participants' time and his or her own time.

In one embodiment, the GST may provide ways to create a pre-event document output that features one or more confirmed-attendees. Although profile photos that show a person's face and biographical information such as hometown and hobbies may be available online via social networks, they are not able to be easily curated into a high-design custom and/or tangible book or document that can be shared with all the participants at an event or in a group (ie, a wedding, a reunion, a conference, a group of people in an office or social club, and/or the like). The finished pre-event document output, in print and/or digital forms, could be used for: weddings, showers, bachelor and bachelorette parties, christenings and new baby parties, family reunions, high school reunions, college reunions, camp reunions, camps, professional groups and associations, sororities, fraternities, office directories, birthday parties, parties, fundraisers, social events, dating profile books, speed dating, speed mentoring, cohorts, school classes, corporate retreats, conferences, professional teams, sports teams, team building exercises, post-event yearbooks, pre-event yearbooks, bar/bat mitzvahs, incoming college freshman books, hiring processes, school directories, funerals, background briefing books, and/or the like.

Some embodiments of the GST automate the process of collecting media which may include photos, videos, audio and other biographical information of event-attendees by pulling from existing servers and/or databases, websites, and/or crowdsourcing from event-attendees. Once media data is curated, a pre-event document template is automatically selected and media is formatted into a photo-bio book. Elements of the book that may be modified include but are not limited to layout, designs, colors, fonts, images, graphics elements, featured video and audio recordings, and/or the like. The finished book can be sent to external commercial printers or be printed on a customer's home or office printer; alternatively or in addition to, the photo-bio book may be produced in a digital form which is optimized for viewing on monitor, mobile, and tablet devices. In addition to image and text elements, digital book may contain video and audio recordings.

The present invention describes a system and method for automatically collecting data about a group of people and formatting said data into a pre-event document output. In the present invention “pre-event document output” or “photo-bio book” may refer to a medium, in printed form, digital form, and/or the like, to present formatted data about one or more confirmed-attendees. The term “data” or “media” may refer to images, text, video and audio elements that may be stored in a computer system. Printed forms may include but are not limited to a book, magazine, newspaper, yearbook, pamphlet, flipbook, photobook, poster, and/or the like. Digital forms may include but are not limited to a websites, blogs, email messages, web-applications, mobile-applications, eBooks, and/or the like.

A photo-bio book may consist of a front cover, a back cover and one or more pages that feature one or more people with an identifying photo and/or video and/or biographical information in text, audio, or video form. Biographical information may consist of elements such as person's name, current profession, fun facts, or relationship to persons in group. Biographical information can be as short as a name or as long as multiple paragraphs. Photo-bio book may include other pages such as title pages, photo collages, photo pages, event information, seating charts, welcome pages, itineraries, maps, table of contents, index, and additional text, audio recordings, video recordings, and figures. The style and format of the photo-bio book may come in any number of different sizes and lengths.

In one embodiment, the term “pages” may be used to refer to physical pages of a printed book that displays data such as images, text and graphic elements. In other embodiments, the pages may be in the form of an electronic document or digital photo-bio book, such as for example a PDF, and/or the like. Pages in a digital photo-bio book may refer to renderings that can be viewed on the display of a device. These renderings may also include but are not limited to components of a website, a mobile device application, an eBook, and/or the like. In a digital photo-bio book, data such as images, text, graphic elements, audio recordings and video recordings may be presented on a page.

In the present invention, “admin user” or “event administrator” refers to a person who initiates the creation of a new photo-bio book and is assigned editing privileges. An admin user may be an event or group organizer. Any admin user can grant admin user status to one or more additional persons. The term “user” or “confirmed-attendee” is used to refer to any person in a group that can interact with the computer system but may not have all privileges that an admin user has.

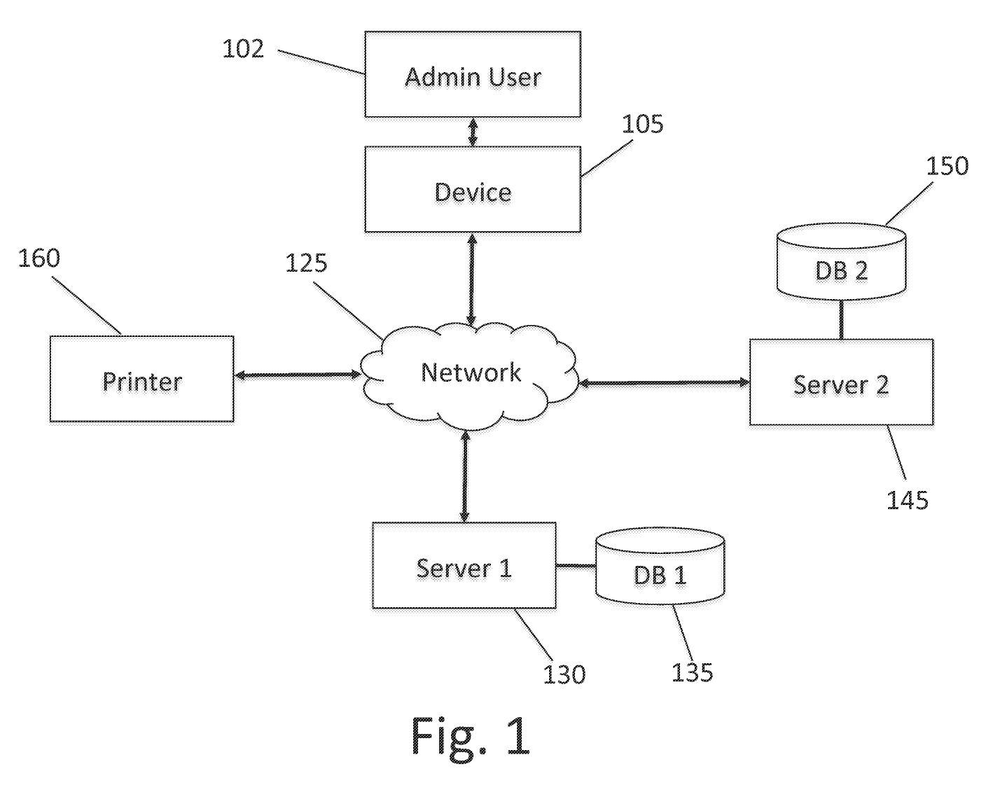

FIG. 1 illustrates a block diagram of a computer system that may be used to implement the teachings of the present invention. The embodiment consists of an admin user 102 who can use a device 105 connected to a network 125. A “network” refers to a network such as the global Internet, but may also include other networks such a local area network or any other computer network that connects one or more servers, computers, or devices together. The device 105 can communicate with a server (Server 1) 130 and corresponding database (Database 1) 135 through the network. Using a device 105, admin user can provide credentials that authorize a pre-event media content aggregation service associated with Server 1 130 to access content associated with a different server (Server 2) 145 and database (Database 2) 150. Data element stored on Server 2 145 and Database 2 150 may optionally be copied to Server 1 130 and Database 1 135.

In the present invention “pre-event media content aggregation service” refers to any method that enables or authorizes a server or computer system to receive at least one pre-event media file associated with at least one confirmed-attendee. The pre-event media content aggregation service may consist of receiving social media credentials from an event administrator or event-attendee and then using said credentials to retrieve at least one pre-event media file from at least one social media service. The pre-event media content aggregation service may provide a least one confirmed-attendee or administrator with a pre-event media-file upload form. This media-file upload form may be a web-based application, mobile application or email.

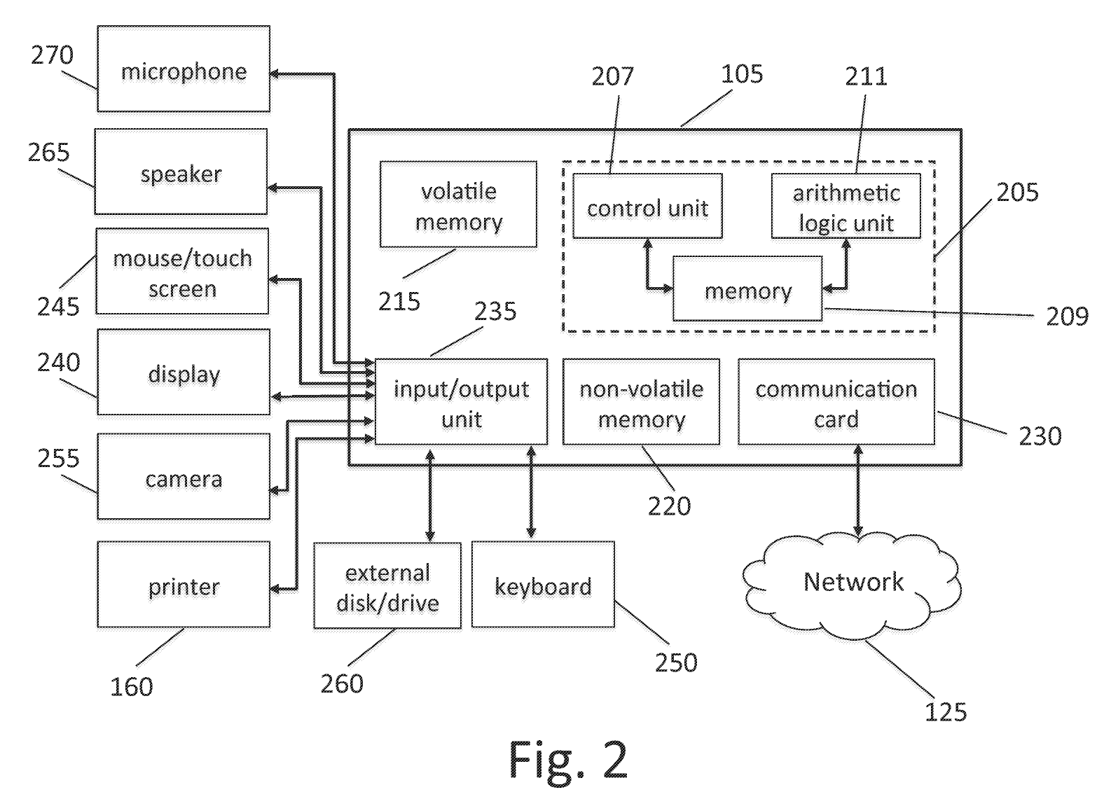

A device 105 illustrated in FIG. 2 represents an exemplified hardware configuration for executing commands and allowing admin users and users to interact with the computer system. In the present invention “device” refers to any computing device with a user interface such as a personal computer, laptop, tablet, or mobile device. The device allows a user to perform tasks such as executing software, manipulating data such as images text, videos, and sound, and communicating with other computers, devices, or servers. The exemplified device 105 consists of a central processing unit (CPU) 205 consisting of a control unit 207, memory 209, and arithmetic logic unit 211. The device may also contains volatile memory 215, non-volatile memory 220 and a communication card 230 which can connect to a server, computing system, or other device via the network 125. The device 105 may also contains an input/output unit 235 that can connect to any following input/output peripherals such as microphone 270, speaker 265, mouse/touchscreen 245, display 240, camera 255, printer 160, keyboard 250, and external disk/drive 260. Any data elements inputted into or recorded onto the non-volatile memory 220 can be uploaded to the server 130. Similarly, data elements including formatted photo-bio book that are located on server 130 may be transferred to device 105 or viewed on device display 240.

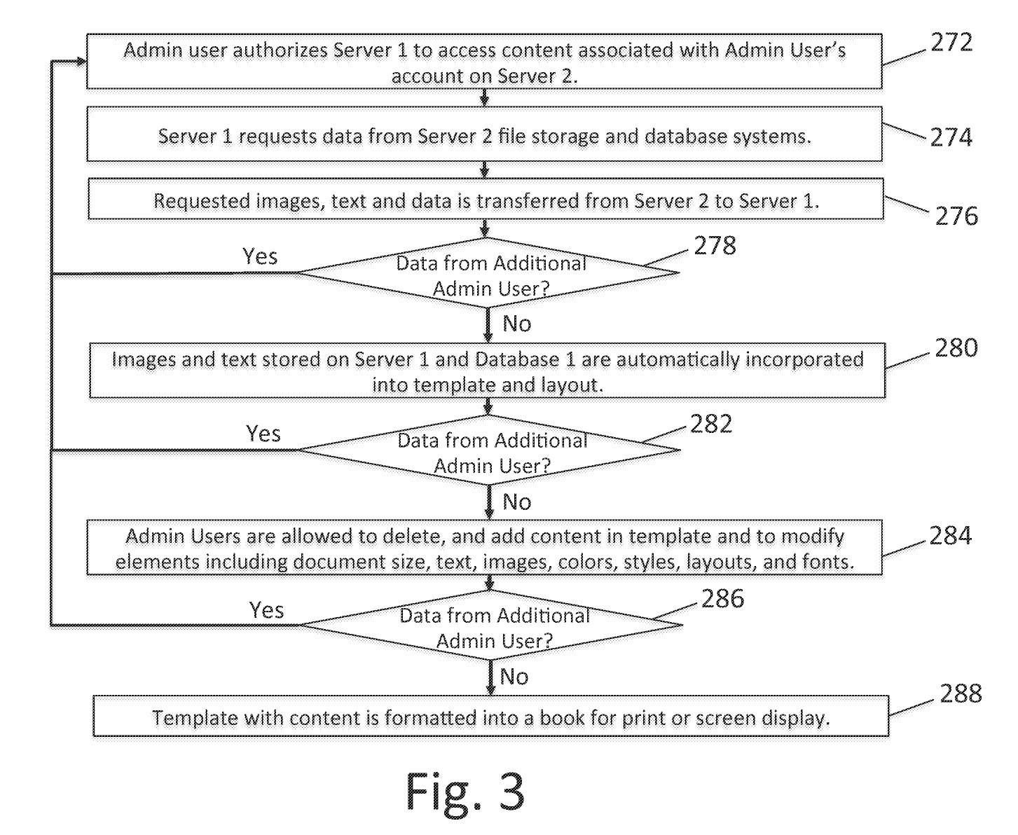

In a preferred embodiment of the present invention, the admin user 102 may initiate the creation of a new photo-bio book. The admin user 102 may add additional admin users whom they wish to have editing privileges and/or data gathering privileges of the photo-bio book. Creation of the photo-bio book may begin with the collection and gathering of data elements. FIG. 3 illustrates a flow diagram that describes a method that may be used to collect data and create a photo-bio book. In step 272 an admin user 102 authorizes server where photo book is generated (Server 1) 130 to access content associated with admin user's account on a different server (Server 2) 145 by supplying the necessary account credentials. For example, Server 2 145 may be a server of a social networking site such as Facebook, Instagram, LinkedIn, Google Plus, Twitter or any other server where images and text are stored (i.e. student database at university). After authorization, Server 1 130 accesses data associated with admin user's account on Server 2 145 (step 274) and requested data is transferred from Server 2 145 to Server 1 130 (step 276). Transferred data may include images, text information, profile information, friend lists, group lists, video recordings, and audio recordings that are associated with admin user's account on Server 2 145. This information in whole or in part may be copied to Server 1 130. Data from additional admin users may be gathered for photo-bio book (step 278). Based on the total number of people to be featured, image dimensions, and length of biographical text (or admin user-specified desired length of biographical text) collected for each person in group, a photo-bio book template and layout is selected and data stored on Server 1 130 is automatically incorporated in to a template and layout (step 280). After rendering of book, additional data for photo-bio book may be added by additional admin users (step 282) and book template and layout is updated to include newly added data elements. Photo-bio book may be rendered for display on a digital medium to allow admin users to preview book. To further customize book, any admin user 102 can modify elements, layouts, and size of photo-bio book (step 284). These modifications may include but are not limited to adding or deleting entire pages to book or changing book size, text content, audio content, video content, images, colors, page styles, and fonts. An admin user may also delete a person from the book or add a person to the book. If the photo-bio book has a cover, said cover may be fully customized to include custom logos, text and images. Step 286 allows additional content to be accessed and incorporated into photo-bio book. After all data has been gathered, and all edits and changes have been made by the admin users, photo-bio book is finalized and formatted for one or more desired book formats (step 288). If book is prepared for print, book may be downloaded to a device 105 and printed on a connected printer 160. Book may also be sent over a network 125 to be printed by a commercial printer 160 and book binding facility. If final book format is digital, digital photo-bio book may be hosted on Server 1 130, or hosted on any other server, or may be download to any number of devices.

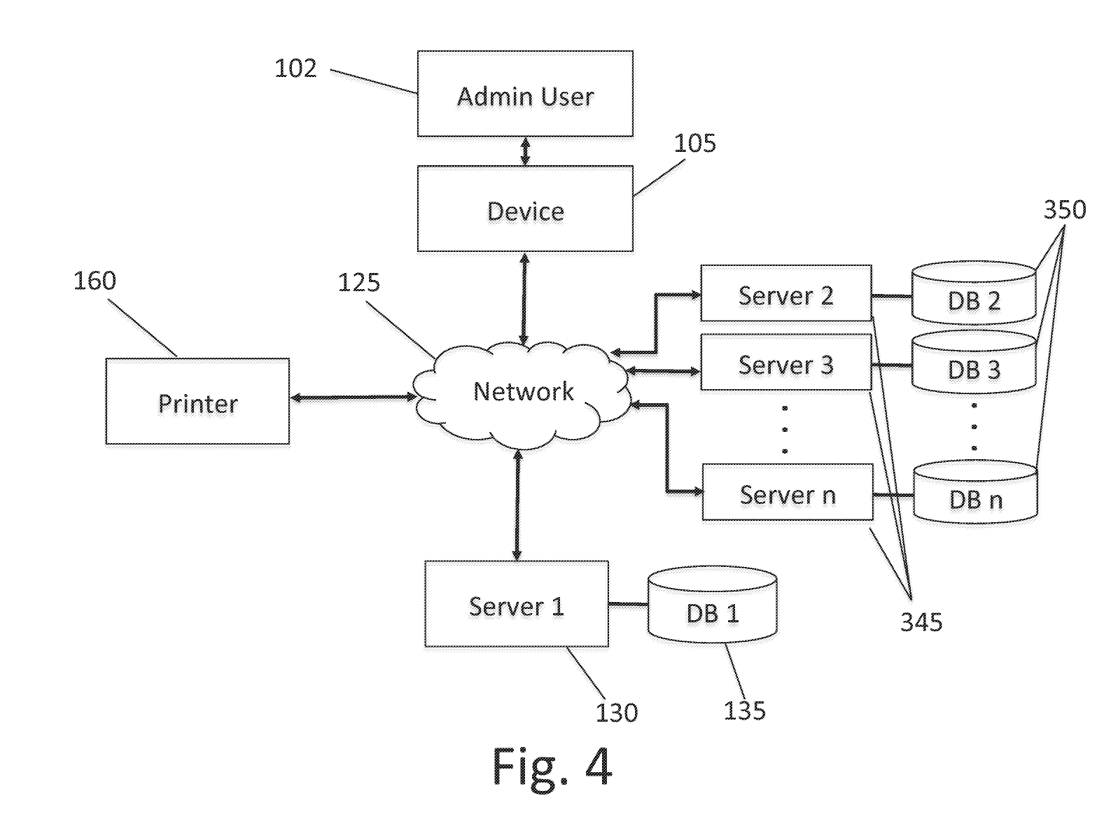

FIG. 4 illustrates a block diagram of a computer system that may be used to collect data from one or more servers 345 with one or more corresponding databases 350. This embodiment will enable one or more admin users to incorporate data associated with one or more of their accounts on any number of different servers.

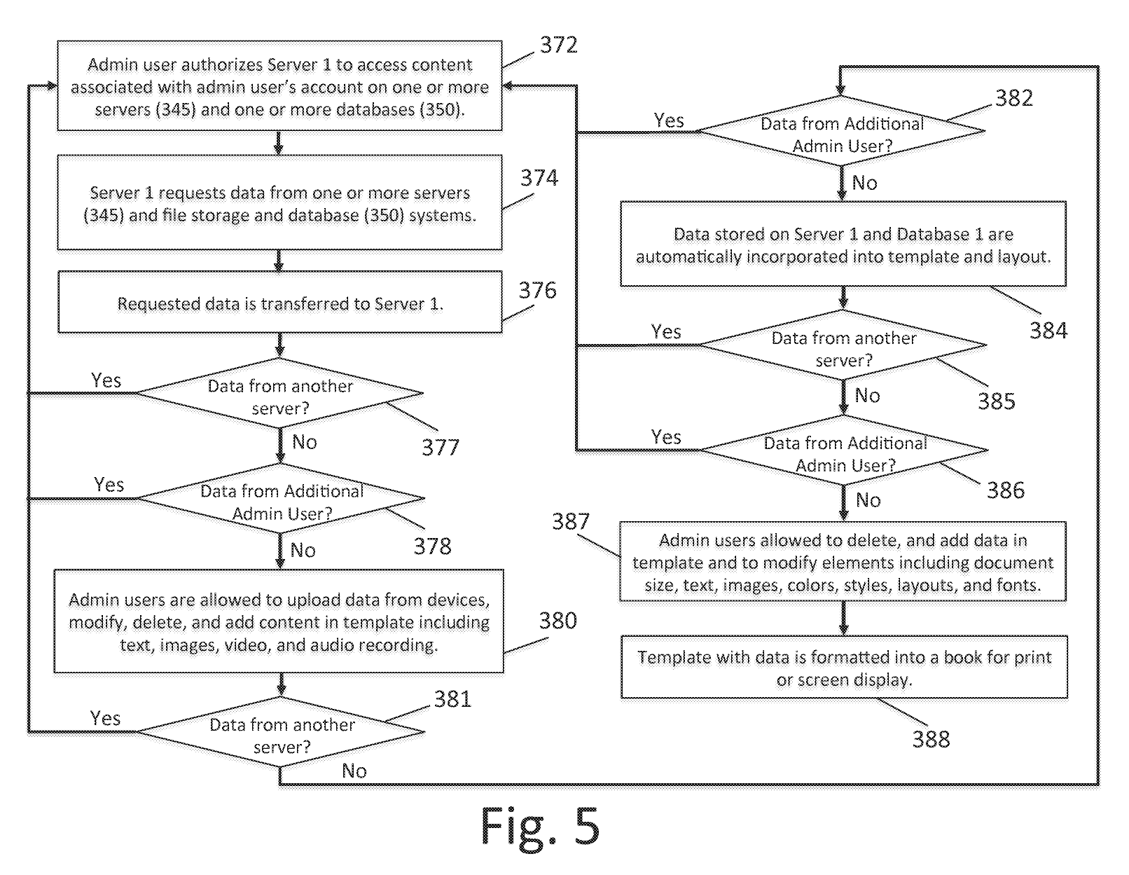

FIG. 5 illustrates a flow diagram that describes a method that may be used to collect data from one or more servers and create a photo-bio book. An admin user 102 may authorize Server 1 130 to access content associated with admin user's account on one or more servers (step 372). Server 1 130 may request and copy data from authorized servers (steps 374, 376). An admin user may authorize content to be gathered from an additional server (step 377) and a different admin user may authorize one or more of their accounts to be used to gather data for the photo-bio book (step 378). Any admin user may upload data from device's non-volatile memory 220 (step 380). At any point in data gathering or stage in incorporating data into photo-bio book, any user may authorize content from one or more servers to be accessed by Server 1 130 (steps 381, 382, 385, 386). Based on the image dimensions and length of biographical text collected for each person in group a pre-event document template is selected and data stored on Server 1 130 is automatically incorporated into a layout (step 384). To further customize book, any admin user 102 can modify elements, layouts, and page size of photo-bio book (step 387). These modifications may include but are not limited to adding or deleting entire pages to book or changing book size, text content, images, colors, page styles, and fonts. An admin user may also delete a person from the book or add a person to the book. An admin user may also associate collected or uploaded video or audio recordings with any person in the book to be used in digital editions. Once content is finalized the completed book is created and optimized for print and/or screen display (step 388).

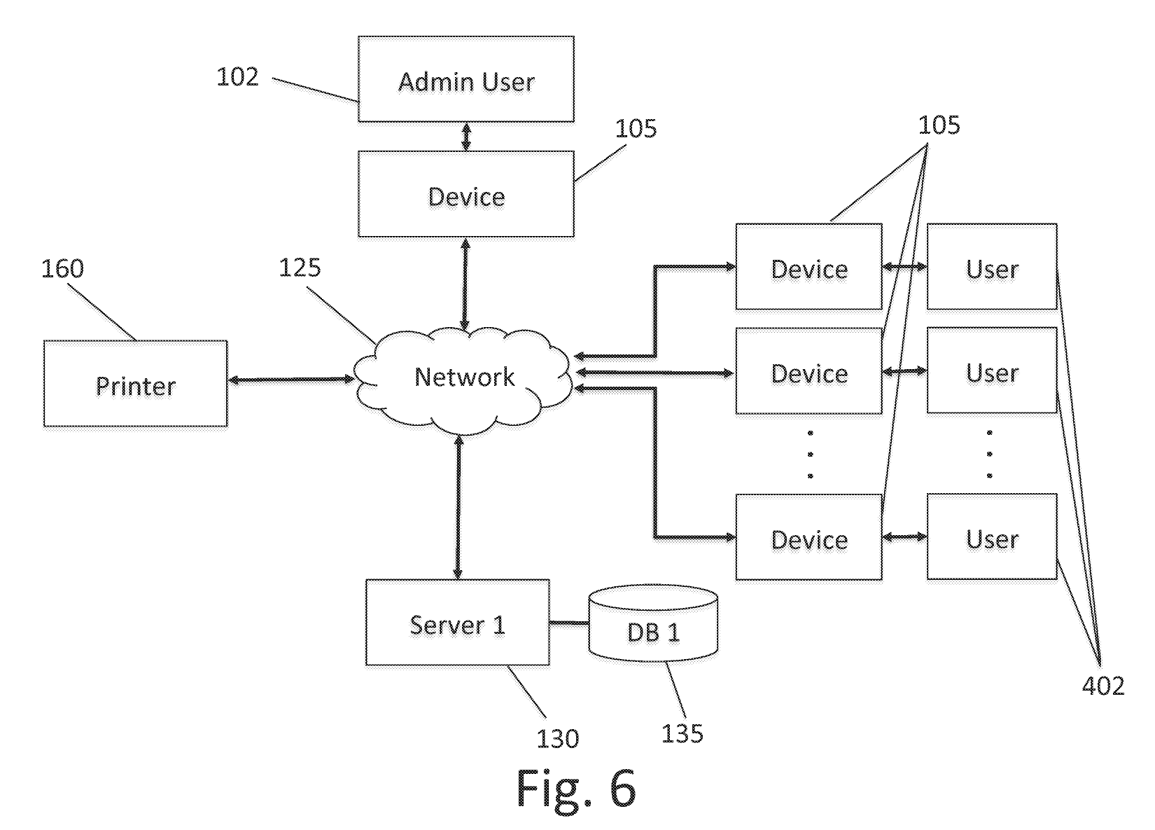

FIG. 6 illustrates a block diagram of a computer system that enables an alternate embodiment of the present invention. This embodiment depicts a computer system consisting of one or more devices 105 that are used by one or more users 402 to generate content for a photo-bio book. This embodiment relates to the crowd-sourcing of data. In the present invention the term “crowd-sourcing” is used to describe a method of gathering data where data is created by a number of individual contributors called users 402. Data may be inputted by user 402 through a device 105 or may be uploaded from the device's non-volatile memory 220. This data may be collected and stored on Server 130. Collected data may then be used to create a photo-bio book.

In a preferred embodiment of the present invention, the admin user 102 may initiate the creation of a new photo-bio book. The admin user may add additional admin users whom they wish to have editing privileges of the photo-bio book.

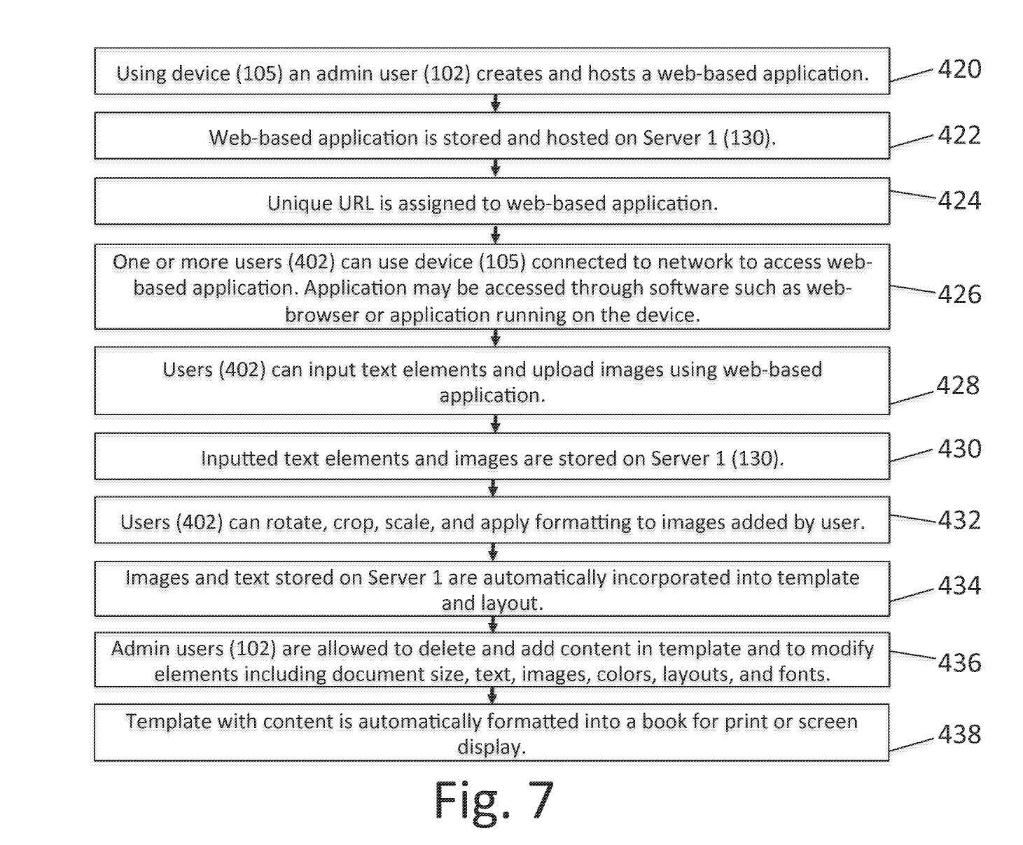

FIG. 7 illustrates a flow diagram that describes a method that may be used to crowd-source data for a photo-bio book and to automatically format data into book for print or digital display. Using a device 105 an admin user may initiate the creation of and host a web-based application to be shared with a group of people (step 420). The group of people may be specified using an event confirmed-attendee data import. This data import may consist of a list of names, email address, or other identifying characteristics. The web-based application may be hosted on Server 1 130 (step 422). A unique pre-event media content submission endpoint may be assigned to web-based application to allow users to access application via the Internet (step 424). In the present invention “unique pre-event media content submission endpoint” can refer to a unique uniform resource locator (URL). The unique URL may be chosen randomly by computer system, or an admin user may choose a more descriptive URL name. The unique pre-event media content submission endpoint may allow user to access a pre-event media file upload form. The file upload form may be a web-based application that allows any user to create, modify, and upload a pre-event media file that may be used in the creation of the photo-bio book. In the present invention the term “pre-event media file” or “data” or “media” is used to refer to any data or media elements such as images, text, video and audio elements that may be stored as a file, set of files, or as part of a database on a computer system. The web-based application may consist of a form that allows users to input their name and potentially other biographical information. Form may also allow a user to upload images, video recordings, and audio recordings. User may access form using unique URL (step 426). User may input one or more text elements and one or more images or data elements which are stored on Server 1 130 (steps 428, 430). The web-based application may allow user to edit, rotate, crop, scale, and apply image-processing algorithms to images and videos added by the user (step 432). Web-based application may allow user to review inputted data. Based on the data properties and length of biographical text elements, information added by each user is automatically incorporated into book layout and template (step 434). To further customize book, any admin user can modify elements, layouts, and size of photo-bio book (step 436). These modifications may include but are not limited to adding or deleting entire pages, changing book size, text content, audio or video recordings, images, colors, page styles, and fonts. An admin user may also delete a person from the book or add a person to the book. Once content is finalized the completed book is created and optimized for print and/or screen display (step 438).

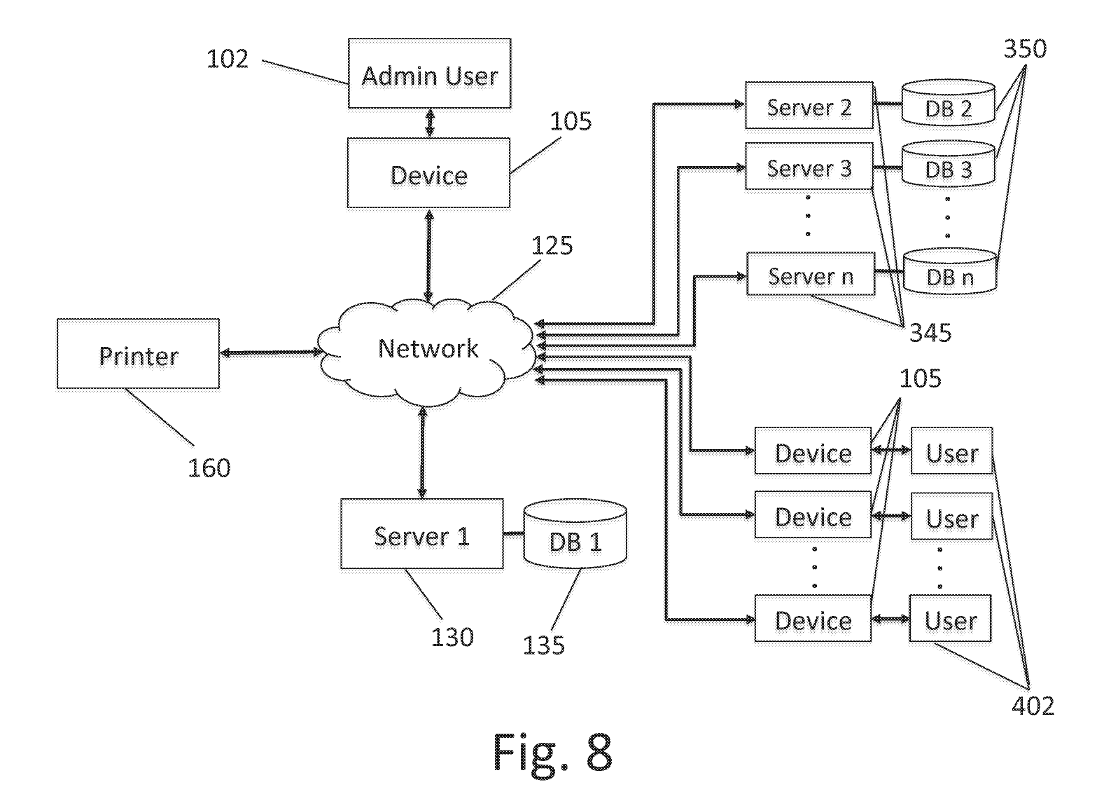

FIG. 8 illustrates a block diagram of a computer system comprised of multiple a number of servers 345 and databases 350 and a number of devices 105 that are connected via a network 125 such as the global Internet. This embodiment enables an admin user 102 to use a number of different data gathering methods to automatically source and generate data for a photo-bio book. Like previously described embodiments Server 1 130 may be authorized to access other servers 345 and collect data from other servers. Other servers may include but are not limited to many popular social networking websites. An admin use 102 may also implement crowd-sourcing method of gathering data as described in FIG. 7. The combination of these data gathering method and others may be used to generate content for a photo-bio book. This computer system also enables a created photo-bio book to be distributed in digital form to any number of admin users or users. This computer system also enables a created photo-bio book to be physically printed a by commercial printers or on a home printing device.

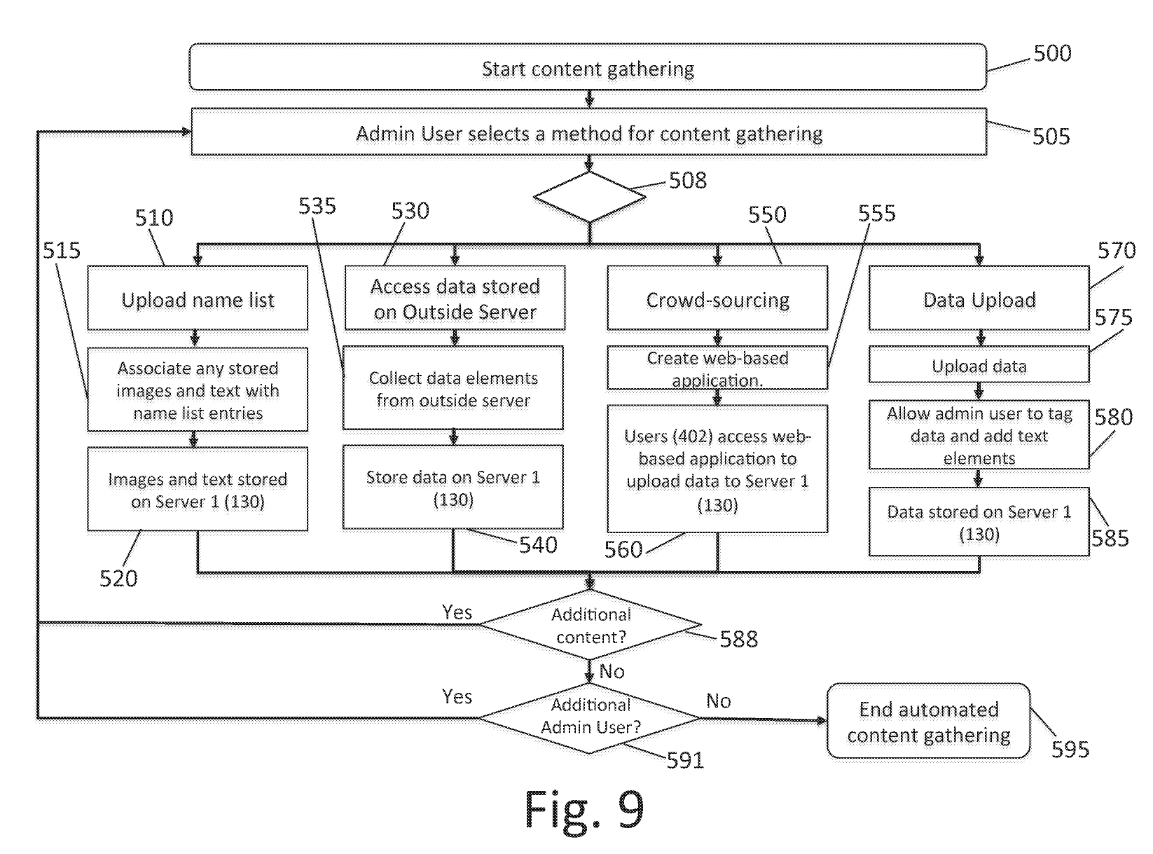

FIG. 9 illustrates a flow diagram that describes several methods of collecting data for a photo-bio book. After initiating the creation of a new photo-bio book, the content gathering may start (step 500) and an admin user selects a method for content gathering (step 505, 508). If admin user chooses to upload name list (step 510), admin user may enter a list of names they wish to feature in the photo-bio book. Alternatively, admin user may upload a data file containing the list on names of people to feature in the book. Uploaded name list may be stored on Server 1. Computer system may search Server 1 130 and associated Database 1 135 for additional data associated with each name on the list. If admin user has previously authorized Server 1 130 to access one or more servers 345 computer system searches for data elements associated with these names on authorized servers 345 and databases 350 (step 515). If any associations are found, associated data elements are stored on Server 1 (step 520). Admin user may choose to add additional content using another method (step 588) and/or additional admin users are able to add content (step 591).

At any time, alternatively or in addition to, admin user may request to access data stored on admin user's accounts on authorized servers (step 530). If a name list has already been uploaded using steps 510, 515, 520 computer system may choose to only copy data elements from authorized servers 345 if they are associated with persons on the name list. If name list has not been uploaded data elements including names, images, text, video, and friend lists may be stored to server 1 (step 535, 540).

At any time, alternatively or in addition to, an admin user may use crowd-sourcing method outlined in FIG. 7 to collect and store data on Server 1 130 (steps 550, 555, 560).

At any time, alternatively or in addition to, an admin user may choose to upload data directly from non-volatile memory 220 on device 105 or from any external disk/drive 260, memory card, or networked data storage system (steps 570, 575). An admin user may tag uploaded data elements and add additional text and/or audio and/or video elements (step 580). Tagging elements may be used to specify which person the element relates to, or may be used to indicate how specific elements should be displayed on specific pages. Uploaded and inputted data is stored on Server 1 130.

An admin user 102 may repeated the data gathering steps described in any combination or any number of times. More than one admin user may complete the steps as outlined FIG. 9 until content gathering for the photo-bio book is completed (step 595).

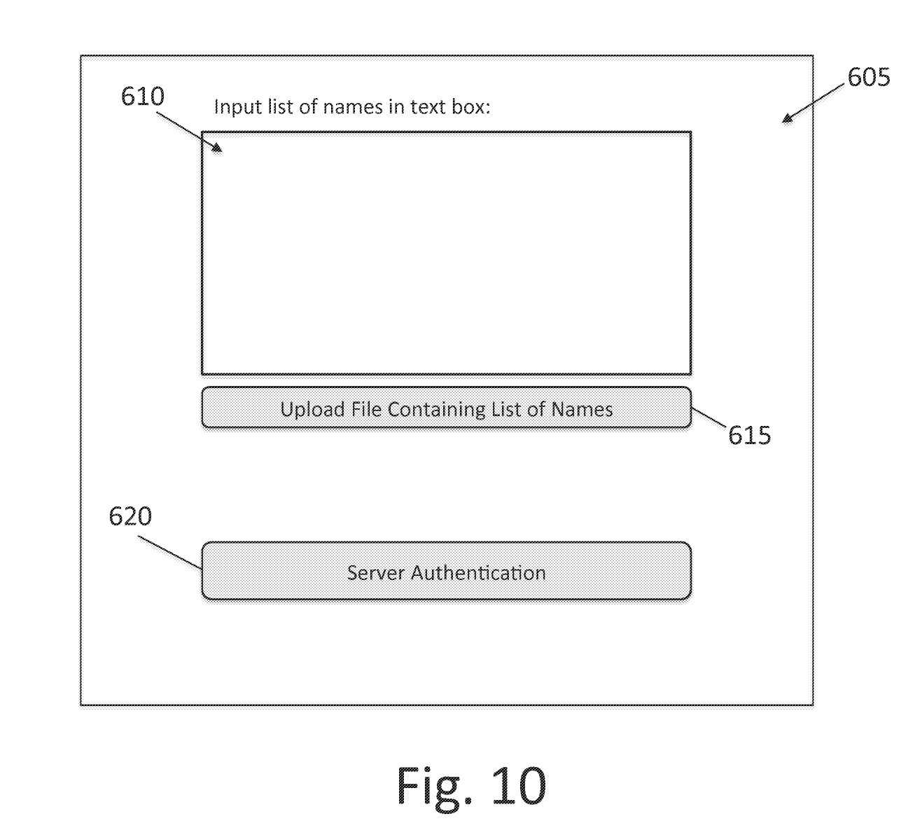

FIG. 10 is an exemplified user interface 605 for inputting a name list. An editable text region 610 may be used to type or copy a list of names that make up a group. Alternatively, a file containing a list of names of people in a group may be uploaded using button 615. A different button on user interface may be used to allow an admin user to authorize Server 1 130 to access content associated with admin user's account on one or more servers 345. After authorization computer system may search on authorized servers 345 for data elements that are associated with each name on the name list. If associated data elements are found they are copied to Server 1 130 and may be incorporated into photo-bio book.

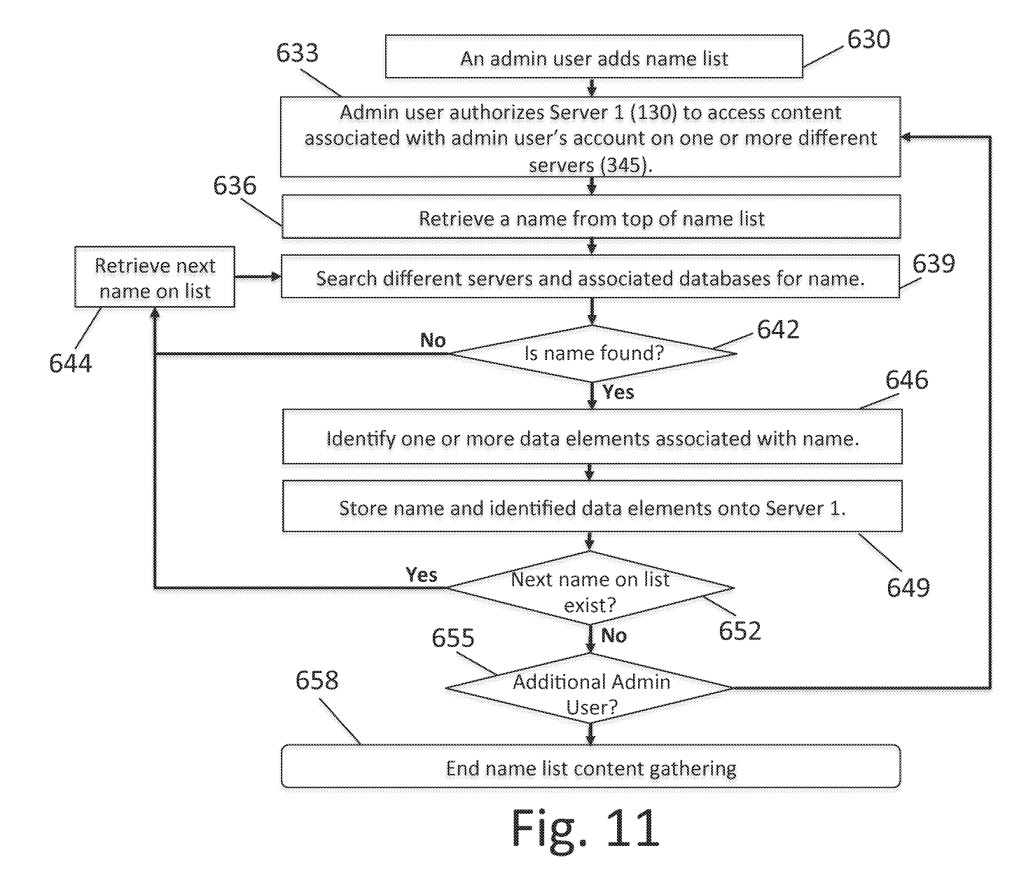

FIG. 11 illustrates a flow diagram that describes how a list of names to be included in photo-bio book may be matched with data elements that are stored on a server or database. An admin user may input a name list using a user interface as exemplified by FIG. 10 (step 630). Admin user may authorize Server 1 130 to access content associated with admin user's account on one or more different servers (step 633). The computer system retrieves name from the top of the name list (step 636). Computer system searches authorized servers 345 and databases 350 for retrieved name (step 639). If the name is not found (step 642), name is stored on Server 1 130. If another name exists on the name list the next name on the name list is selected (step 644) and the authorized servers 345 and databases 350 are searched for this new name. If the name is found on one or more servers 345 or databases 350 in step 642, data elements associated with that particular name are identified (step 646). These data elements and name are stored on Server 1 130 (step 649). If another name on the name list exists (step 652) next name on list is retrieved (step 644) and name matching process is repeated. If another name on the name list does not exist (step 652) and if there exists one or more additional admin users (step 655), other admin users may authorize their accounts on servers 345 and databases 350 to be searched for corresponding names (step 633) and the matching process is repeated. When there are no more names to search and no more admin users the content gathering and name list matching is ended (step 658).

Content gathering for photo-bio book as described in FIGS. 3, 5, and 9 may begin with admin user authorizing Server 1 130 to access content associated with one or more servers 345.

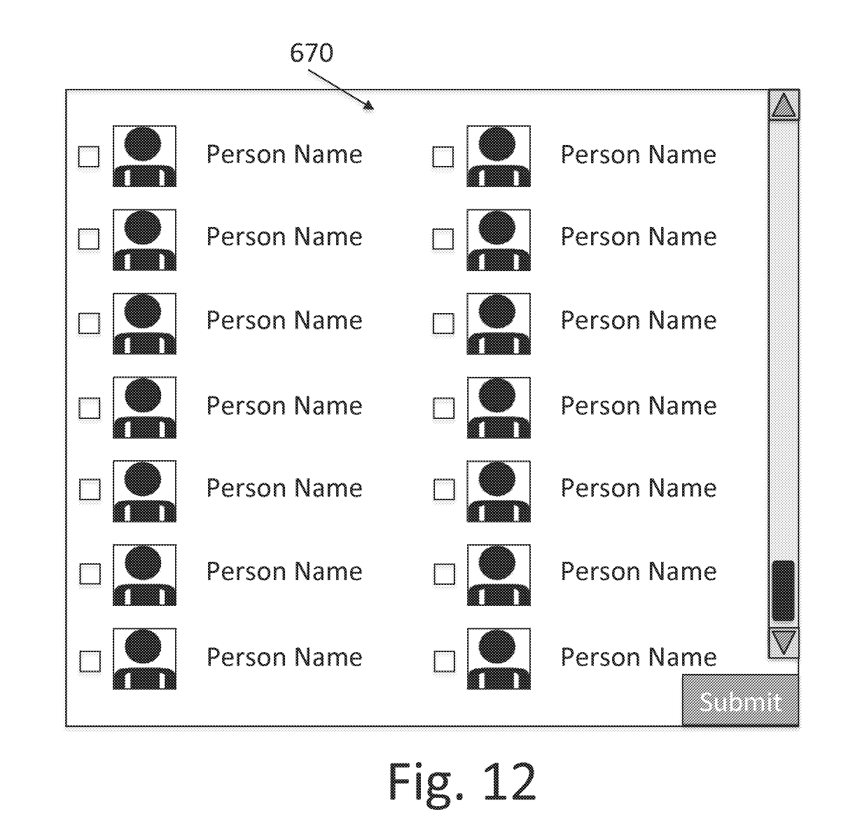

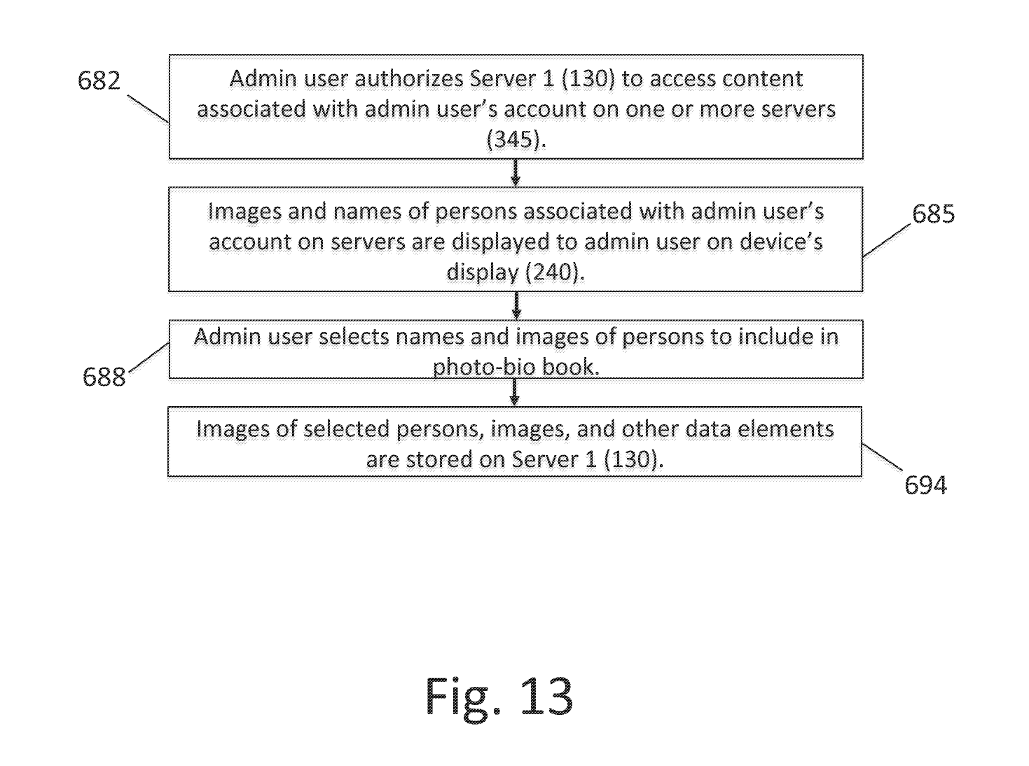

FIGS. 12 and 13 depict one embodiment of how data associated with authorized servers may be selected for incorporation into photo-bio book. An admin user may authorize Server 1 130 to access content associated with admin user's account on one or more servers (step 682). Content consisting of the image and name of persons associated with one or more admin user's account on authorized servers 345 may be displayed in a user interface 670 (step 685). Admin user may view list of people and select each person they wish to include in photo-bio book (step 688). Selections may be made by clicking on a person's photograph, name, or adjacent checkbox in the exemplary user interface 670. After group of people from interface have been selected admin user may click “submit” and photo, name, biographical text, and other data elements associated with person is copied and stored onto Server 1 130 (step 694). This data may then be used to generate a photo-bio book containing the selected people.

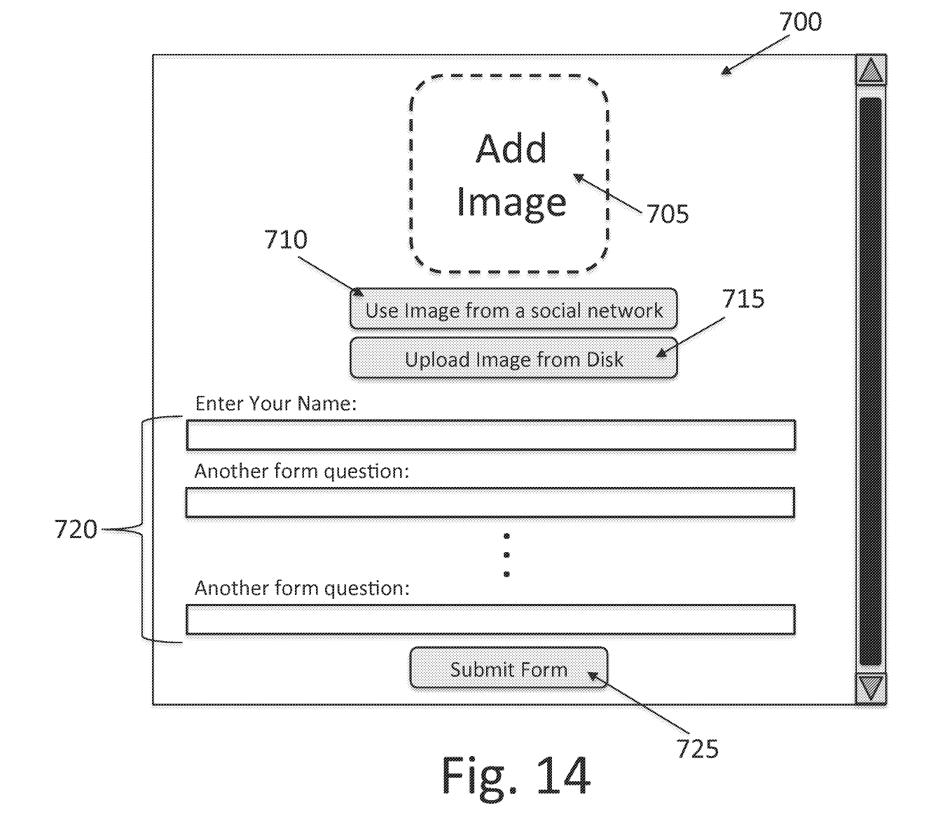

FIG. 14 is an exemplified user interface 700 of a web-based application that may be used to collect data, from one or more users, for a photo-bio book. This web-based application is an example of a crowd-sourcing web-based application that can be generated by an admin user and then used to collect content for a photo-bio book. Web-based application may consist of an image preview window 705 and buttons 710, 715 to allow user to use their profile image associated with a social networking website or to upload a different image from a disk or non-volatile memory on device 105. In addition the user interface may contain a number of form elements 720 where specific text, video, or audio elements may be added. Web-based application may also contain a button 725 that saves data element inputted through web-based application Server 1 130.

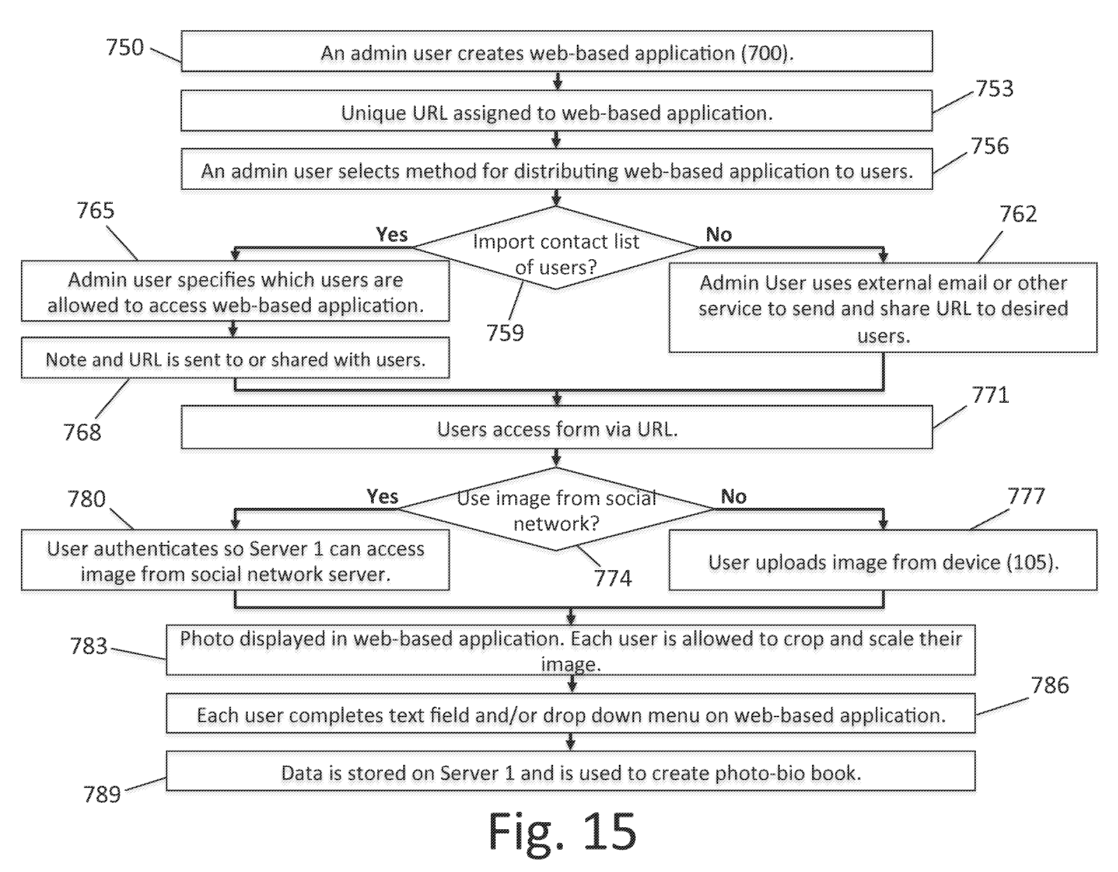

FIG. 15 illustrates a flow diagram that describes a crowd-sourcing method of collecting data, from one or more users, for a photo-bio book. An admin user may create a web-based application 700 (step 750), assign a unique URL to the web-based application (step 753), and select a method for distributing web-based application to users 402. If the admin user chooses to import contact information for the group of people to be featured in photo-bio book (i.e., email addresses) (steps 759, 765) a note containing the URL to the web-based application may be sent to or shared with users (step 768). If admin user choose not to add or import an email list (step 759) admin user may use an external service (i.e., email or text message) to send URL to desired users (step 762). Each user may then access web-application using URL (step 771). Each user may choose to select their image and other data elements from a social network (step 774) and after authenticating with social network, image is transferred to Server 1 (step 780). If user chooses not to use a social network to get an image or other data, they may upload image and other data elements from the non-volatile memory 220 on device 105 or from any external disk/drive 260, memory card, or networked data storage system (step 777). Selected photo and/or other data elements are then displayed in web-based application and user is allowed to crop and scale their image (step 783) and/or edit video and audio files. User completes text fields and other data input field on web-based application (step 786). In general, data inputted through web-based application is not limited to text and may include all data element types including video and audio recordings. All collected data is stored on Server 1 130 and may be used in the creation of the photo-bio book (step 789).

In another embodiment of the present invention, a web-browser applet may be used to easily gather data for a photo-bio book. In the present invention an “applet” refers to any software or computer code that can be run from a web-browser and can be executed while viewing a number of different web pages. Such an applet may be programmed in JavaScript but other programming languages may enable the same functionality.

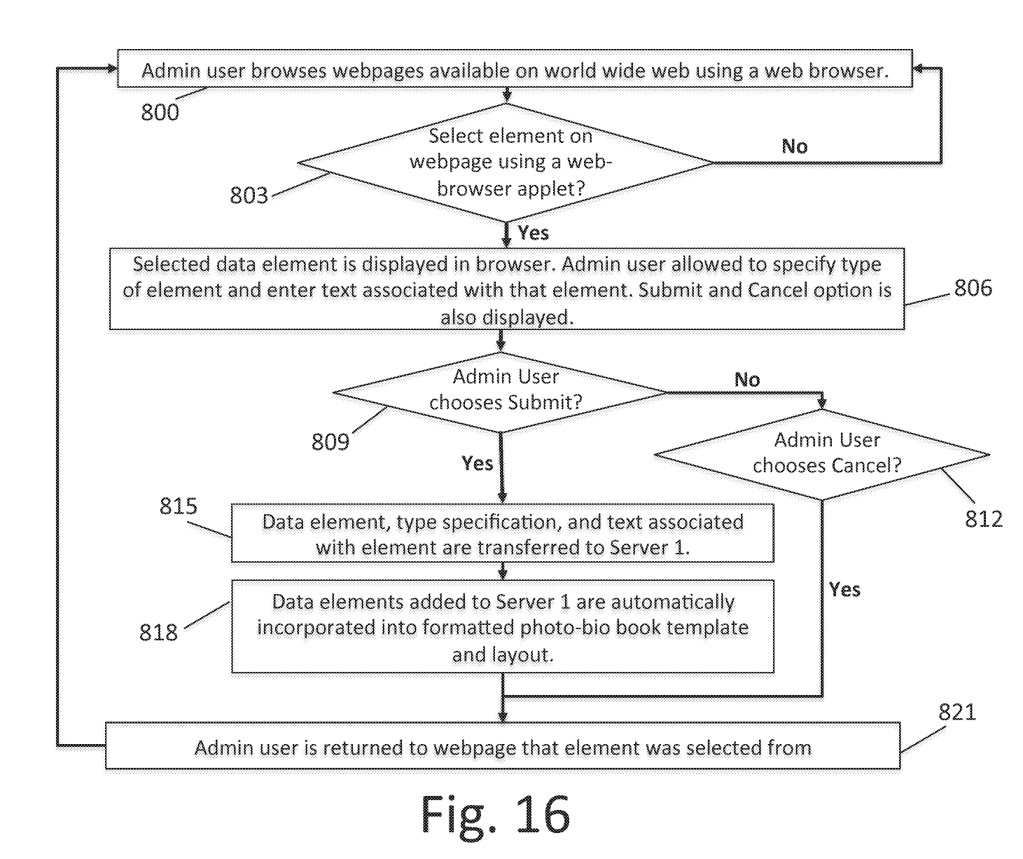

FIG. 16 illustrates a flow diagram that describes a method of collecting data for a photo-bio book that uses a web-browser applet. Admin user may browse a webpage available on the Internet using a web browser (step 800). Admin user may use applet to select data element in current browser frame (step 803). Applet displays selected element in browser and allows user to specify type of element and enter any text or identifying tags associated with element (step 806). Admin user may choose to submit element (step 809) and data element with text and identifying tags are transferred to Server 1 130 (step 815). Data element may then be automatically incorporated into a photo-bio book template and layout (818). Admin user is then returned to webpage from which element was selected from (step 821) and is allowed to continue browsing for more content. If admin user chooses to cancel rather than submit element (step 812) admin user is also allowed to return to browsing the web without storing selected element on server 1 130 or database 1 135.

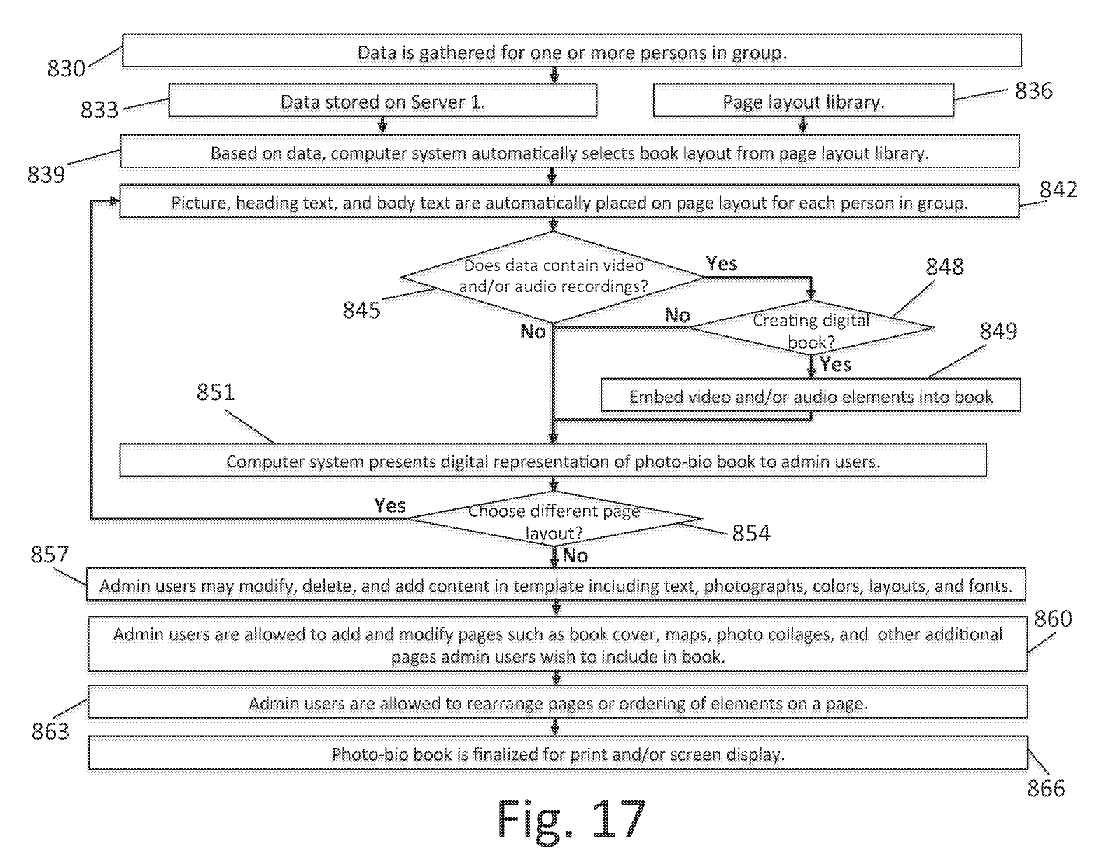

FIG. 17 illustrates a flow diagram that describes a method of automatically formatting data into a photo-bio book. Data about a group of people may be collected using any number of methods described in the present invention (step 830). Once collected these data elements are stored on Server 1 130 (step 833). Based on the properties of the stored data elements, the page layouts for the photo-bio book are automatically selected by the computer system. Page layouts are comprised of a number of sections per page. Each section may consist of one or more image frames, a heading text, and a body text. The heading text is often the name of the person or persons featured in each section. However, the heading text may contain other text information that can help identify or describe the person or persons in each section. The body text may include additional text information relating to or about the person or persons. Automated selection of book layout may be based on the number of images per section, the size and dimensions of the images, the heading text length, and the body text length.

Once layout has been selected, picture, heading text, and body text are automatically placed on page layout for each person in group (step 842). Images will be automatically sized to best fit into template. If data stored on Server 1 contains video or audio recordings (step 845) and if digital book is being created (step 848) these video and audio elements are imbedded into photo-bio book (step 849). Corresponding icons may be displayed in digital book to allow video and audio elements to be accessed and viewed.

Once book has been automatically generated by computer system a digital representation of the photo-bio book may be displayed for admin users (step 851). An admin user may choose to select a different layout for the book (step 854). If a different layout is selected data elements are reformatted to match admin user's request. In addition to being able to modify different page layouts, admin user is allowed to add and modify pages such as book cover, maps, photo collages, and other additional pages admin users wish to include in photo-bio book (step 860). Admin users may also rearrange pages or ordering of sections on a page (step 863). While editing book, admin user may change photos, zoom in and out of photos, write, add, and edit text, choose a different design, and move people to special pages (for example, a “speaker” page or a “bridesmaid” page).

In a digital iteration of the book, an admin user may choose to include photos and/or video of group members, and biographical information may be included and feature in text and/or audio and/or video formats. Once admin users have completed all edits and changes to photo-bio book, book can then be finalized for print and/or screen display (step 866).

When admin user has successfully completed photo-bio book with all desired participants or group members and design, color, and style elements are to their satisfaction, admin user may choose between a number of methods to create printed book or display book in a digital format. Photo-bio book may be sent to a commercial printer and binding facility. Alternatively, photo-bio book may be printed on a networked printed or a local printed connected to the device 105. For production of digital version of photo-bio book, it may be compiled into a mobile app, or may be hosted as a web-application on Server 1 or any other server. The book may also be converted into PDF document or an eBook.

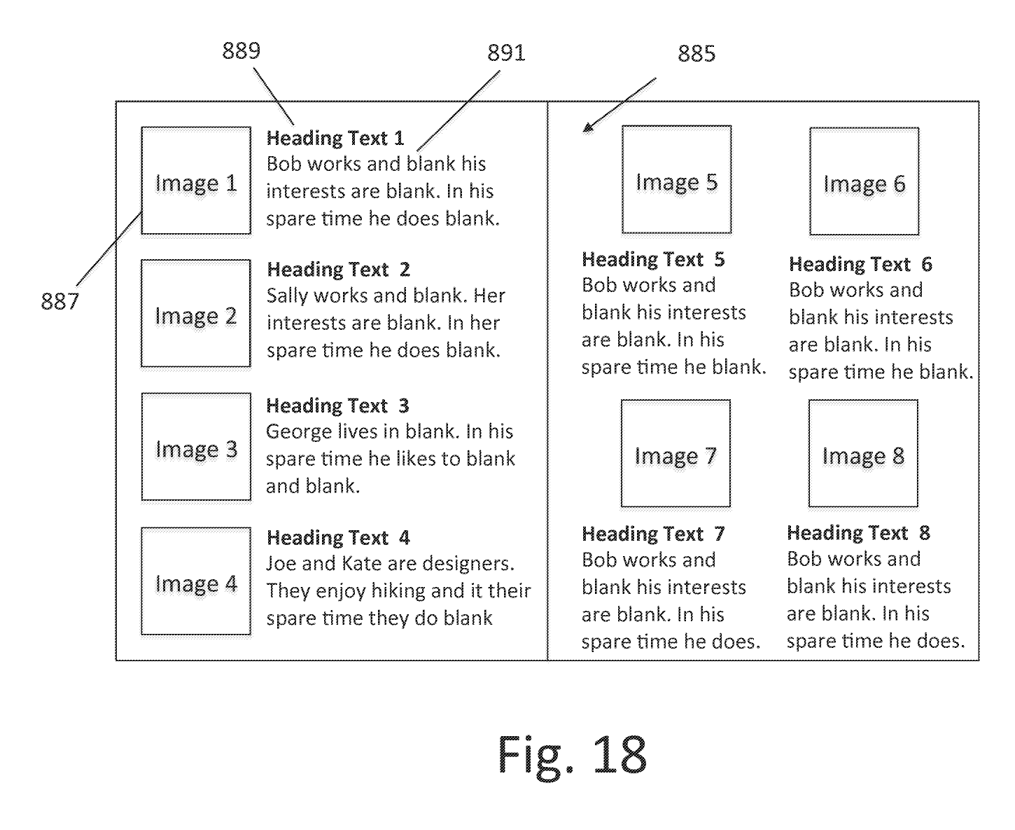

FIG. 18 is an exemplified formatting and layout for a photo-bio book 885. Each person's profile in the book may consist of an image representation of the person 887, heading text 889 and body text 891 that is related to the person. This type of formatting may be ideal for printed version of the book.

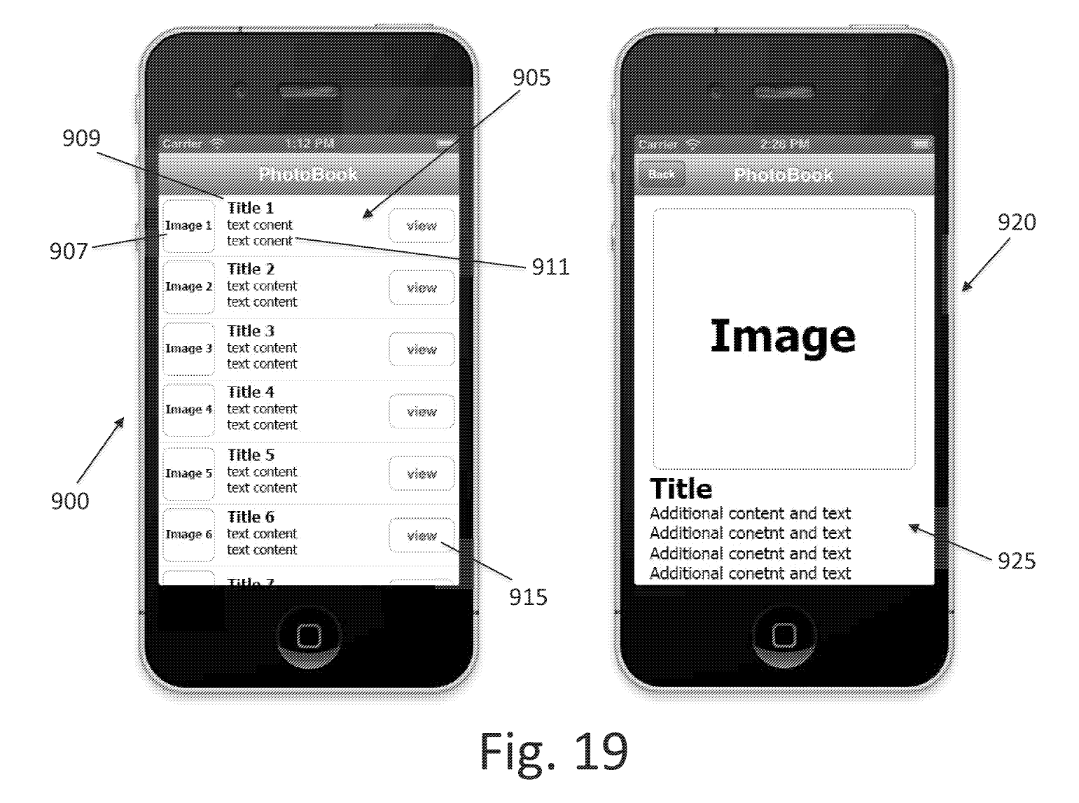

FIG. 19 is an exemplified photo-bio book in digital form as displayed on a device. The photo-bio book 900 may consist of a number of sections 905 where each section contains a profile for each person. Each person's profile may be represented by an image or video representation of the person 907, a heading text 909 that may be the person's name or may be other identifying text. The body text 911 may include some abbreviated text content related to the person. The profile of each person may also contain a selection area 915 that allows a longer version of the person's profile to be viewed. This longer version is depicted in 920. The longer version may display a larger image and may contain additional text and/or audio information 925.

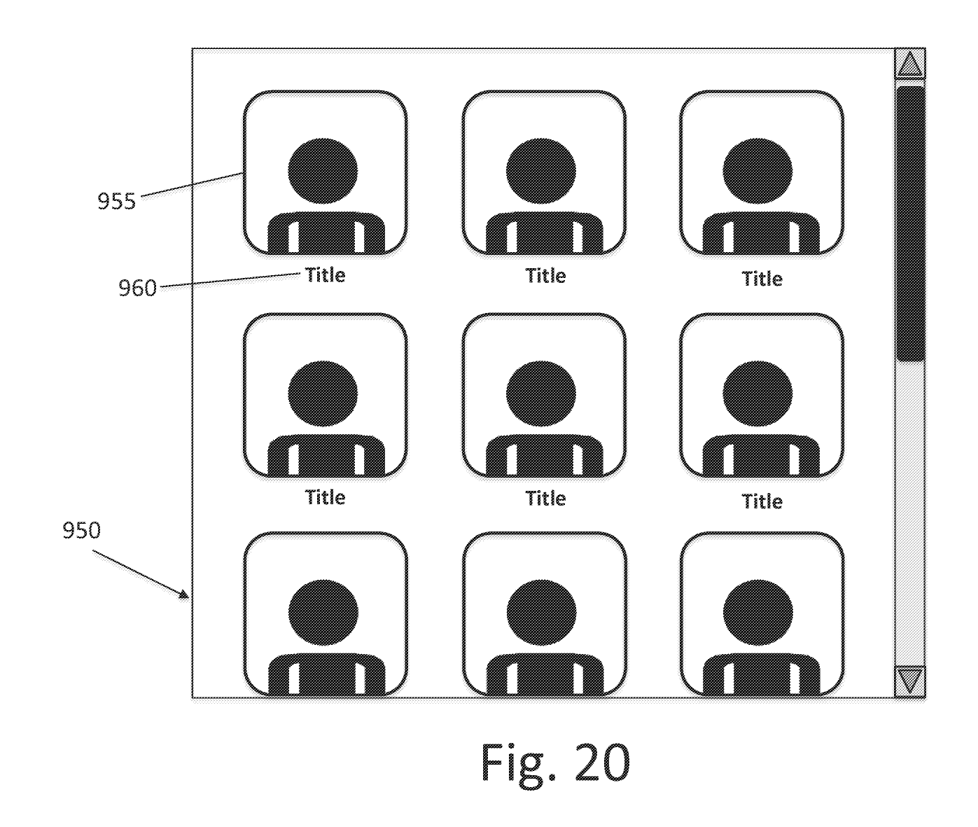

FIG. 20 is an exemplified digital photo-bio book 950 as displayed on a device. This embodiment of the digital photo-bio book consists of a page of images 955 representing each person in a group. In addition to an image, book may consist of a title element 960 which may specify the person's name or other textual information. In addition to image and text elements, video and/or audio recording may be incorporated into digital book design. For example, in one exemplary embodiment, user my select image or title of person using a mouse/touch screen 245 to start playing a video or audio recording associated with that person.

In the preceding description a number of different computer systems and methods have been presented on generating and gathering content about a group of people to be featured in a photo-bio book and the automatic formatting of said content into a photo-bio book. The use of one method or any combination of the methods presented in the current embodiment provide a number of novel ways of creating a photo-bio book that may be produced for digital or print mediums.

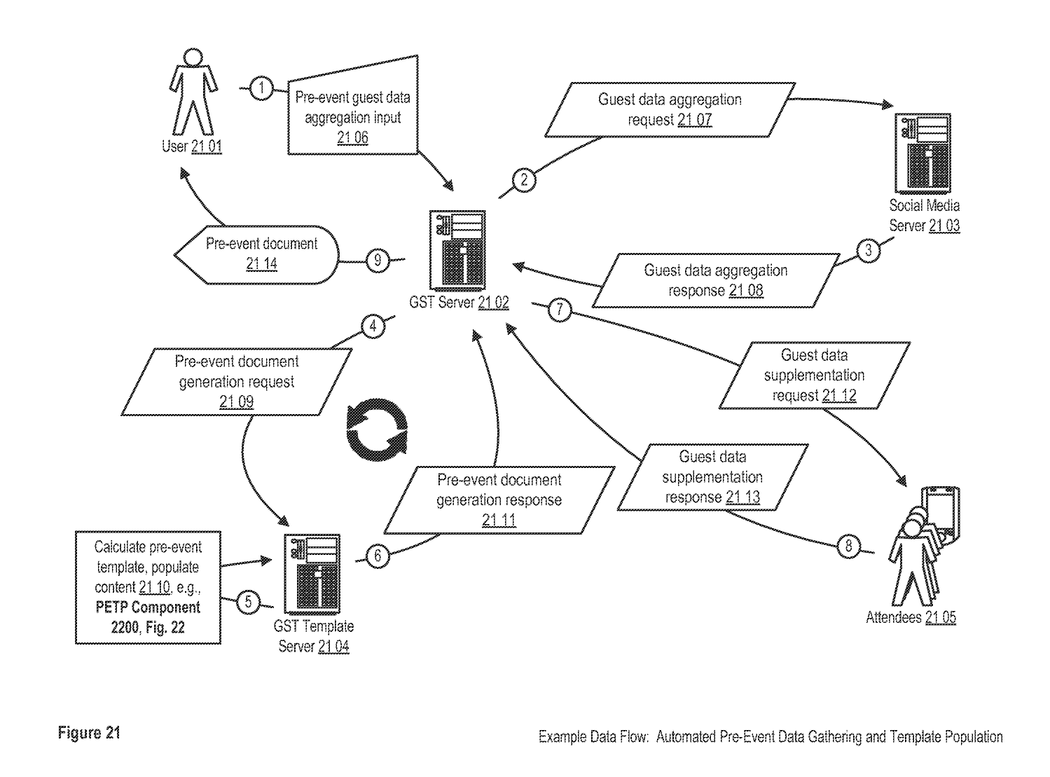

FIG. 21 shows an example data flow illustrating aspects of automated pre-event data gathering and template population, in one implementation of the GST operation. In one embodiment, user 2101 may desire to input a guest list and have the GST server 2102 automatically aggregate data from the user's social media accounts. Furthermore, user 2101 may desire to generate a pre-event document utilizing the aggregated content. In some embodiments, social media server 2103 may provide insufficient data regarding an event's guest list and as such may require supplemental data aggregation.

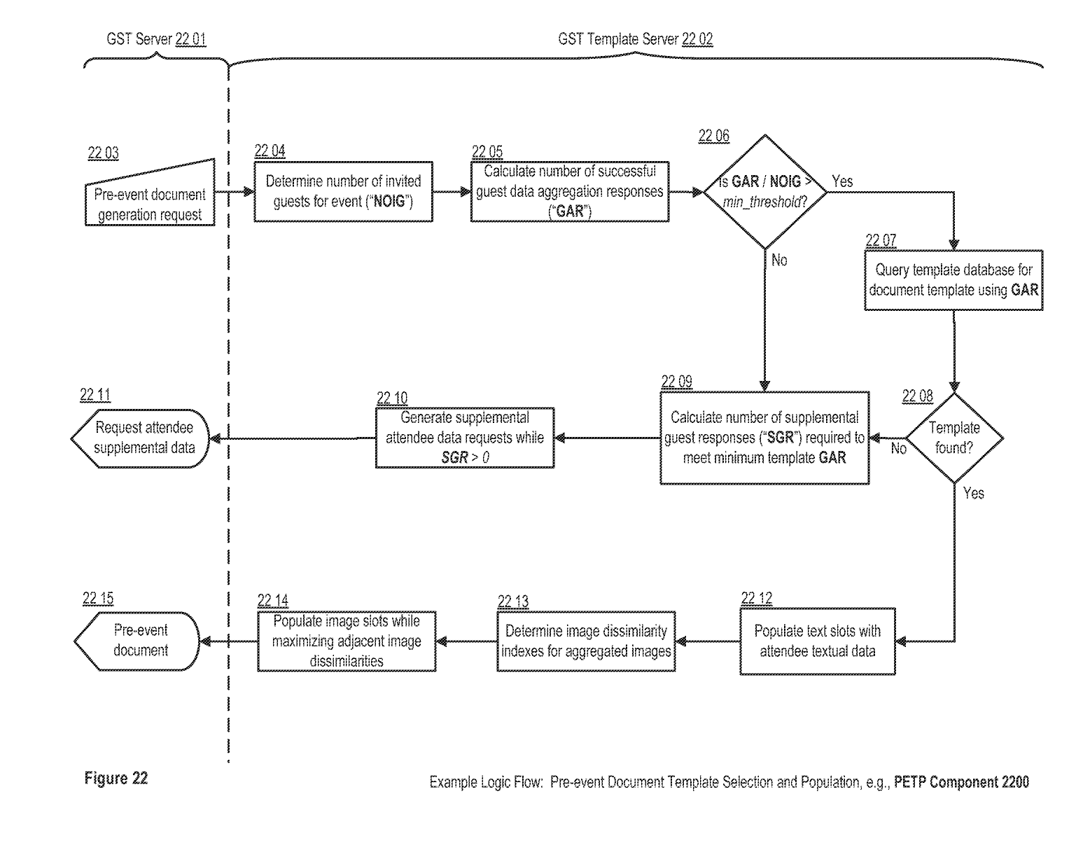

In one embodiment, user 2101 may provide a pre-event guest data aggregation input 2106 to GST server 2102. GST server 2102 may thereafter parse the guest data aggregation input and extract user 2101 social media credentials, an event attendee list, and/or the like. In one embodiment, GST server 2102 may initiate a guest data aggregation request 2107 to social media server 2103. Social media server 2103 may provide an application programming interface and or API for interfacing with GST server 2102 on the user's behalf. In one embodiment, social media server 2103 may return a plurality of textual and/or image-based data regarding guests associated with the event guest data aggregation input, e.g. guest data aggregation response 2108. In other embodiments, social media server 2103 may aggregate data from other users' social media accounts, such as data available publicly and/or with public availability social media settings. In one embodiment, GST server 2102 may initiate a pre-event document generation request 2109 using the guest data aggregation response 2108 to generate a template-based pre-event document for transmission and/or sending to event attendees prior to event commencement. GST template server 2104 may calculate an appropriate template and populate the template with image, textual, and/or the like content, e.g. 2110. Further detail with regard to pre-event template population may be found with respect to PETP Component 2200, e.g. FIG. 22. In one embodiment, GST template server 2104 may return a pre-event document generation response 2111 to GST server 2102. If the pre-event document generation response indicates that enough guest data has not been aggregated in order to populate a minimum event document template, GST server 2102 may initiate a guest data supplementation request 2112. In some embodiments, a guest data supplementation request is a request to attendees to provide images and/or biographical data to GST server 2102 to supplement and/or correct data received from social media server 2103. Guest data supplementation requests 2112 may be transmitted directly to user devices, sent as an email to user email accounts associated with social media server 2103, transmitted as a text message with a clickable hyperlink, and/or the like. In one embodiment, a plurality of attendees 2105 may provide a guest data supplementation response 2113 to GST server 2102. As a result, GST server 2102 may get initiate a pre-event document generation request 2109 and/or receive a pre-event document generation response 2111. The aggregation and generation cycles may repeat until a successful pre-event document has been generated, e.g. 2114.

FIG. 22 shows an example logic flow illustrating aspects of pre-event document template selection and population, e.g., an example PETP Component, in one implementation of the GST operation. In one embodiment, GST server 2201 may transmit a pre-event document generation request 2203 to GST template server 2202. The GST template server may determine the number of invited guests for an event. The number of invited guests may be the total number of guests invited to the event by a user. The GST template server may then process the pre-event document generation request to determine the number of successful guest data aggregation responses, e.g. 2205, received. A guest data aggregation response may be a response from a user social media site and/or the like providing images and/or biographical data related to potential event attendees. If the ratio of guest data aggregation responses to the number of invited guests is greater than a minimum threshold set by the GST administrator, e.g. 2206, a template database may be queried for a suitable template to represent at least the number of successful guest data aggregation responses, e.g. 2207. If a template is not found, e.g. 2208, a number of supplemental guest responses required in order to meet the minimum template requirements, e.g. 2209, may be calculated. In one embodiment, if a minimum event template requires at least 10 guests attending the event to have photos available for inclusion in the document, yet only seven guest data aggregation responses have been received, the GST template server may generate and/or instruct the GST server 2201 to generate three supplemental guest response requests. In one embodiment, the GST template server 2202 may generate supplemental attendee data requests while the number of supplemental guest responses received is less than the required amount, e.g. 2210. GST server 2201 may thereafter request attendees to submit supplemental data, e.g. 2211. In one embodiment, if GST template server 2202 finds a template, e.g. 2208, then text slots within the template may be populated with textual attendee data, e.g. 2212. The template server may thereafter determine image dissimilarity indexes for the received aggregated images, e.g. 2213. Image dissimilarity indexes may be determined by, for example, comparing the color profiles of received aggregated images, comparing the number of faces detected in received aggregated images, calculating a male to female ratio in received aggregated images, and/or the like. In one embodiment, GST template server 2202 may populate image slots within the template in such a manner so as to maximize the dissimilarity between adjacent images. In so doing, the GST may produce visually appealing pre-event documents, e.g. 2215, in a pleasing visual configuration.

### GST Controller

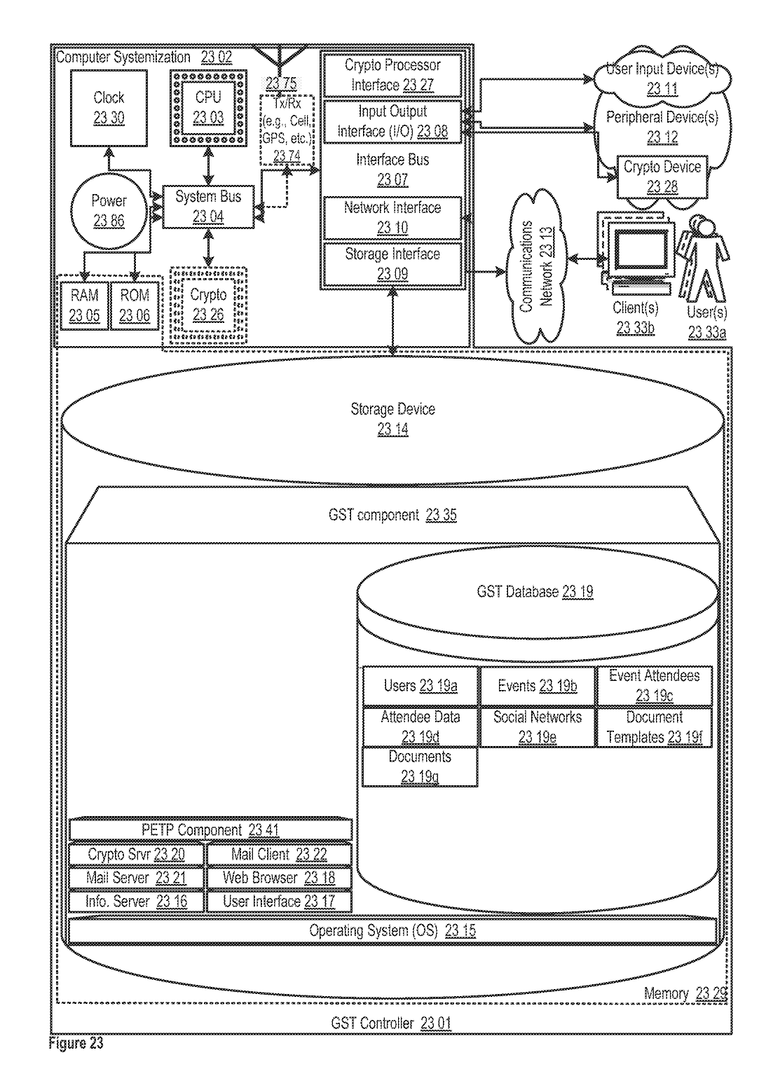

FIG. 23 shows a block diagram illustrating embodiments of a GST controller. In this embodiment, the GST controller 2301 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 2303 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2329 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the GST controller 2301 may be connected to and/or communicate with entities such as, but not limited to: one or more users from user input devices 2311; peripheral devices 2312; an optional cryptographic processor device 2328; and/or a communications network 2313.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The GST controller 2301 may be based on computer systems that may comprise, but are not limited to, components such as: a computer systemization 2302 connected to memory 2329.

### Computer Systemization

A computer systemization 2302 may comprise a clock 2330, central processing unit (“CPU(s)” and/or “processor(s)” (these terms are used interchangeable throughout the disclosure unless noted to the contrary)) 2303, a memory 2329 (e.g., a read only memory (ROM) 2306, a random access memory (RAM) 2305, etc.), and/or an interface bus 2307, and most frequently, although not necessarily, are all interconnected and/or communicating through a system bus 2304 on one or more (mother)board(s) 2302 having conductive and/or otherwise transportive circuit pathways through which instructions (e.g., binary encoded signals) may travel to effectuate communications, operations, storage, etc. The computer systemization may be connected to a power source 2386; e.g., optionally the power source may be internal. Optionally, a cryptographic processor 2326 and/or transceivers (e.g., ICs) 2374 may be connected to the system bus. In another embodiment, the cryptographic processor and/or transceivers may be connected as either internal and/or external peripheral devices 2312 via the interface bus I/O. In turn, the transceivers may be connected to antenna(s) 2375, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing GST controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2329 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the GST controller and beyond through various interfaces. Should processing requirements dictate a greater amount speed and/or capacity, distributed processors (e.g., Distributed GST), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the GST may be achieved by implementing a microcontroller such as CAST's R8051 XC2 microcontroller; Intel's MCS 51 (i.e., 8051 microcontroller); and/or the like. Also, to implement certain features of the GST, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the GST component collection (distributed or otherwise) and/or features may be implemented via the microprocessor and/or via embedded components; e.g., via ASIC, coprocessor, DSP, FPGA, and/or the like. Alternately, some implementations of the GST may be implemented with embedded components that are configured and used to achieve a variety of features or signal processing.

Depending on the particular implementation, the embedded components may include software solutions, hardware solutions, and/or some combination of both hardware/software solutions. For example, GST features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the GST features. A hierarchy of programmable interconnects allow logic blocks to be interconnected as needed by the GST system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the GST may be developed on regular FPGAs and then migrated into a fixed version that more resembles ASIC implementations. Alternate or coordinating implementations may migrate GST controller features to a final ASIC instead of or in addition to FPGAs. Depending on the implementation all of the aforementioned embedded components and microprocessors may be considered the “CPU” and/or “processor” for the GST.

### Power Source

The power source 2386 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2386 is connected to at least one of the interconnected subsequent components of the GST thereby providing an electric current to all subsequent components. In one example, the power source 2386 is connected to the system bus component 2304. In an alternative embodiment, an outside power source 2386 is provided through a connection across the I/O 2308 interface. For example, a USB and/or IEEE 1394 connection carries both data and power across the connection and is therefore a suitable source of power.

### Interface Adapters

Interface bus(ses) 2307 may accept, connect, and/or communicate to a number of interface adapters, conventionally although not necessarily in the form of adapter cards, such as but not limited to: input output interfaces (I/O) 2308, storage interfaces 2309, network interfaces 2310, and/or the like. Optionally, cryptographic processor interfaces 2327 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2309 may accept, communicate, and/or connect to a number of storage devices such as, but not limited to: storage devices 2314, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2310 may accept, communicate, and/or connect to a communications network 2313. Through a communications network 2313, the GST controller is accessible through remote clients 2333b (e.g., computers with web browsers) by users 2333a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed GST), architectures may similarly be employed to pool, load balance, and/or otherwise increase the communicative bandwidth required by the GST controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2310 may be used to engage with various communications network types 2313. For example, multiple network interfaces may be employed to allow for the communication over broadcast, multicast, and/or unicast networks.

Input Output interfaces (I/O) 2308 may accept, communicate, and/or connect to user input devices 2311, peripheral devices 2312, cryptographic processor devices 2328, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2311 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2312 may be connected and/or communicate to I/O and/or other facilities of the like such as network interfaces, storage interfaces, directly to the interface bus, system bus, the CPU, and/or the like. Peripheral devices may be external, internal and/or part of the GST controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the GST controller may be embodied as an embedded, dedicated, and/or monitor-less (i.e., headless) device, wherein access would be provided over a network interface connection.

Cryptographic units such as, but not limited to, microcontrollers, processors 2326, interfaces 2327, and/or devices 2328 may be attached, and/or communicate with the GST controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2329. However, memory is a fungible technology and resource, thus, any number of memory embodiments may be employed in lieu of or in concert with one another. It is to be understood that the GST controller and/or a computer systemization may employ various forms of memory 2329. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 2329 will include ROM 2306, RAM 2305, and a storage device 2314. A storage device 2314 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2329 may contain a collection of program and/or database components and/or data such as, but not limited to: operating system component(s) 2315 (operating system); information server component(s) 2316 (information server); user interface component(s) 2317 (user interface); Web browser component(s) 2318 (Web browser); database(s) 2319; mail server component(s) 2321; mail client component(s) 2322; cryptographic server component(s) 2320 (cryptographic server); the GST component(s) 2335; PETP Component 2341; and/or the like (i.e., collectively a component collection). These components may be stored and accessed from the storage devices and/or from storage devices accessible through an interface bus. Although non-conventional program components such as those in the component collection, typically, are stored in a local storage device 2314, they may also be loaded and/or stored in memory such as: peripheral devices, RAM, remote storage facilities through a communications network, ROM, various forms of memory, and/or the like.

### Operating System

The operating system component 2315 is an executable program component facilitating the operation of the GST controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP/Win7 (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the GST controller to communicate with other entities through a communications network 2313. Various communication protocols may be used by the GST controller as a subcarrier transport mechanism for interaction, such as, but not limited to: multicast, TCP/IP, UDP, unicast, and/or the like.

### Information Server

An information server component 2316 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the GST controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the GST database 2319, operating systems, other program components, user interfaces, Web browsers, and/or the like.

Access to the GST database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the GST. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the GST as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery UI, MooTools, Prototype, script.aculo.us, SWFObject, Yahoo! User Interface, any of which may be used and provide a baseline and means of accessing and displaying information graphically to users.

A user interface component 2317 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2318 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Firefox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the GST enabled nodes. The combined application may be nugatory on systems employing standard Web browsers.

### Mail Server

A mail server component 2321 is a stored program component that is executed by a CPU 2303. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the GST.

Access to the GST mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2322 is a stored program component that is executed by a CPU 2303. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2320 is a stored program component that is executed by a CPU 2303, cryptographic processor 2326, cryptographic processor interface 2327, cryptographic processor device 2328, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the GST may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the GST component to engage in secure transactions if so desired. The cryptographic component facilitates the secure accessing of resources on the GST and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The GST Database

The GST database component 2319 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the GST database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the GST database is implemented as a data-structure, the use of the GST database 2319 may be integrated into another component such as the GST component 2335. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2319 includes several tables 2319a-g. A Users table 2319a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a GST. An Events table 2319b may include fields such as, but not limited to: event_id, event_name, date, invited_guests, confirmed_guests, created_by_user_id, document_id, and/or the like. An Event Attendees table 2319c may include fields such as, but not limited to: event_attendee_id, event_id, attendee_name, attendee_email, attendee_aggregated_data and/or the like. An Attendee Data table 2319d may include fields such as, but not limited to: attendee_data_id, event_attendee_id, data_key, data_value and/or the like. A Social Networks table 2319e may include fields such as, but not limited to: social_network_id, social_network_name, credentials, user_name, password, api_key and/or the like. A Documents Templates table 2319f may include fields such as, but not limited to: document_template_id, minimum_required_images, minimum_required_attendees, template_definition and/or the like. A Documents table 2319g may include fields such as, but not limited to: document_id, user_id, document_template_id, event_id, content and/or the like.

In one embodiment, the GST database may interact with other database systems. For example, employing a distributed database system, queries and data access by search GST component may treat the combination of the GST database, an integrated data security layer database as a single database entity.

In one embodiment, user programs may contain various user interface primitives, which may serve to update the GST. Also, various accounts may require custom database tables depending upon the environments and the types of clients the GST may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2319a-g. The GST may be configured to keep track of various settings, inputs, and parameters via database controllers.

The GST database may communicate to and/or with other components in a component collection, including itself, and/or facilities of the like. Most frequently, the GST database communicates with the GST component, other program components, and/or the like. The database may contain, retain, and provide information regarding other nodes and data.

### The GSTs

The GST component 2335 is a stored program component that is executed by a CPU. In one embodiment, the GST component incorporates any and/or all combinations of the aspects of the GST that was discussed in the previous figures. As such, the GST affects accessing, obtaining and the provision of information, services, transactions, and/or the like across various communications networks. The features and embodiments of the GST discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the GST's features and facilities, and in many cases reduce the costs, energy consumption/requirements, and extend the life of GST's underlying infrastructure; this has the added benefit of making the GST more reliable. Similarly, many of the features and mechanisms are designed to be easier for users to use and access, thereby broadening the audience that may enjoy/employ and exploit the feature sets of the GST; such ease of use also helps to increase the reliability of the GST. In addition, the feature sets include heightened security as noted via the Cryptographic components 2320, 2326, 2328 and throughout, making access to the features and data more reliable and secure.

The GST component may transform pre-event guest data aggregation inputs, and/or the like and use the GST. In one embodiment, the GST component 2335 takes inputs (e.g., pre-event guest data aggregation input 2106, guest data aggregation request 2107, guest data supplementation request 2112, pre-event document generation request 2109 and/or the like) etc., and transforms the inputs via various components (e.g., PETP Component 2341, and/or the like), into outputs (e.g., guest data aggregation response 2108, guest data supplementation response 2113, pre-event document generation response 2111, pre-event document 2114, and/or the like).

The GST component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the GST server employs a cryptographic server to encrypt and decrypt communications. The GST component may communicate to and/or with other components in a component collection, including itself, and/or facilities of the like. Most frequently, the GST component communicates with the GST database, operating systems, other program components, and/or the like. The GST may contain, communicate, generate, obtain, and/or provide program component, system, user, and/or data communications, requests, and/or responses.

### Distributed GSTs

The structure and/or operation of any of the GST node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the GST controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the GST controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
//set ip address and port to listen to for incoming data
$address = ‘192.168.0.100’;
$port = 255;
//create a server-side SSL socket, listen
//for/accept incoming communication
$sock = socket_create(AF_INET, SOCK_STREAM, 0);
socket_bind($sock, $address, $port)

or die(‘Could not bind to address’);

socket_listen($sock);
$client = socket_accept($sock);
//read input data from client device in 1024 byte
//blocks until end of message
do {

$input = “”;
$input = socket_read($client, 1024);
$data .= $input;

} while($input != “”);
// parse data to extract variables
$obj = json_decode($data, true);
// store input data in a database
mysql_connect(″10.1.1.1″,$srvr,$pass); // access database server
mysql_select(″CLIENT_DB.SQL″); // select database to append
mysql_query(“INSERT INTO UserTable (transmission) VALUES
($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?
topic=/com.ibm.IBMDI.doc/referenceguide295.htm

and other parser implementations:

http://publib.boulder.ibm.com/infocenter/tivihelp/v2r1/index.jsp?
topic=/com.ibm.IBMDI.doc/referenceguide259.htm

all of which are hereby expressly incorporated by reference.

In order to address various issues and advance the art, the entirety of this application for GST (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a GST individual and/or enterprise user, database configuration and/or relational model, data type, data transmission and/or network framework, syntax structure, and/or the like, various embodiments of the GST, may be implemented that enable a great deal of flexibility and customization. For example, aspects of the GST may be adapted for restaurant dining, online shopping, brick-and-mortar shopping, secured information processing, and/or the like. While various embodiments and discussions of the GST have been directed to electronic purchase transactions, however, it is to be understood that the embodiments described herein may be readily configured and/or customized for a wide variety of other applications and/or implementations.

What is claimed is:

1) A processor-implemented method for automated pre-event media collection and pre-event media distribution, comprising:
receiving, from an event administrator, an event confirmed-attendee data import;
generating, for at least one confirmed-attendee, at least one unique pre-event media content submission endpoint, wherein the confirmed-attendee is associated with at least one record in the event confirmed-attendee data import;
transmitting, to the at least one confirmed-attendee, the at least one unique pre-event media content submission endpoint corresponding to the confirmed-attendee;
providing, in response to an electronic request from the at least one confirmed-attendee, a pre-event media content aggregation service;
receiving, from the at least one confirmed-attendee, at least one pre-event media file associated with at least one confirmed-attendee; and
generating, upon receipt of a minimum quanta of at least one pre-event media files associated with at least one confirmed-attendee, a pre-event document output.

2) The method of claim 1 wherein the pre-event media content aggregation service is an electronic service comprising:
receiving, from at least one confirmed-attendee, at least one confirmed-attendee social media credential;
retrieving, using the at least one confirmed-attendee social media credential, at least one pre-event media file from at least one social media service.

3) The method of claim 2 additionally comprising:
receiving a permission indication from the at least one confirmed-attendee granting permission to gather at least one pre-event media file associated with at least one second confirmed-attendee.

4) The method of claim 1, wherein the pre-event media content aggregation service is a service comprising:
providing the at least one confirmed-attendee with a pre-event media file content upload form.

5) The method of claim 1 additionally comprising automatically retrieving at least one publicly available pre-event media file associated with at least one confirmed-attendee.

6) The method of claim 5 additionally comprising emailing at least one confirmed-attendee to request approval to use the retrieved at least one publicly available pre-event media file associated with at least one confirmed-attendee.

7) The method of claim 1 additionally comprising:
receiving at least one social media credential for at least one social media account associated with the event administrator; and
retrieving at least one non-publicly available pre-event media file associated with the event administrator using the at least one social media credential.

8) The method of claim 1 additionally comprising:
receiving, from the event administrator, at least one indication of at least one featured confirmed-attendee.

9) The method of claim 8, wherein the minimum quanta of pre-event media files must contain at least one pre-event media file associated with each of the at least one featured confirmed-attendee.

10) The method of claim 1 additionally comprising:
issuing reminders to submit at least one pre-event media file to at least one confirmed-attendee.

11) The method of claim 1, additionally comprising:
determining, using the minimum quanta of at least one pre-event media files, a pre-event document template.

12) The method of claim 11 additionally comprising:
populating the pre-event document template with the minimum quanta of at least one pre-event media files.

13) The method of claim 12 additionally comprising:
providing the populated pre-event document template as a pre-event document for transmission to the at least one confirmed-attendee.

14) The method of claim 13 wherein the pre-event document is a physical book imprinted with the minimum quanta of at least one pre-event media files.

15) The method of claim 13 additionally comprising:
allowing the event administrator to customize the populated pre-event document template.

16) An automated pre-event media collection and pre-event media distribution apparatus, comprising:
a memory; and
a processor disposed in communication with said memory, and configured to issue a plurality of processing instructions stored in the memory, wherein the processor issues instructions to:
receive, from an event administrator, an event confirmed-attendee data import;
generate, for at least one confirmed-attendee, at least one unique pre-event media content submission endpoint, wherein the confirmed-attendee is associated with at least one record in the event confirmed-attendee data import;
transmit, to the at least one confirmed-attendee, the at least one unique pre-event media content submission endpoint corresponding to the confirmed-attendee;
provide, in response to an electronic request from the at least one confirmed-attendee, a pre-event media content aggregation service;
receive, from the at least one confirmed-attendee, at least one pre-event media file associated with at least one confirmed-attendee; and
generate, upon receipt of a minimum quanta of at least one pre-event media files associated with at least one confirmed-attendee, a pre-event document output.

17) The apparatus of claim 16 wherein the pre-event media content aggregation service is an electronic service additionally comprising instructions to:
receive, from at least one confirmed-attendee, at least one confirmed-attendee social media credential;
retrieve, using the at least one confirmed-attendee social media credential, at least one pre-event media file from at least one social media service.

18) A non-transitory medium storing automated pre-event media collection and pre-event media distribution instructions to:
receive, from an event administrator, an event confirmed-attendee data import;
generate, for at least one confirmed-attendee, at least one unique pre-event media content submission endpoint, wherein the confirmed-attendee is associated with at least one record in the event confirmed-attendee data import;
transmit, to the at least one confirmed-attendee, the at least one unique pre-event media content submission endpoint corresponding to the confirmed-attendee;
provide, in response to an electronic request from the at least one confirmed-attendee, a pre-event media content aggregation service;
receive, from the at least one confirmed-attendee, at least one pre-event media file associated with at least one confirmed-attendee; and
generate, upon receipt of a minimum quanta of at least one pre-event media files associated with at least one confirmed-attendee, a pre-event document output.

19) The medium of claim 18 wherein the pre-event media content aggregation service is an electronic service additionally comprising instructions to:
receive, from at least one confirmed-attendee, at least one confirmed-attendee social media credential;
retrieve, using the at least one confirmed-attendee social media credential, at least one pre-event media file from at least one social media service.
